(19) United States
(12) Patent Application Publication
(10) Pub. No.: US 2023/0227940 A1
(43) Pub. Date: Jul. 20, 2023

(54) RECOVERY OF VANADIUM FROM ALKALINE SLAG MATERIALS

(71) Applicant: AVANTI MATERIALS LTD, West Perth, Western Australia (AU)

(72) Inventors: David ROBINSON, West Perth (AU); Mark Daniel URBANI, West Perth (AU)

(21) Appl. No.: 17/760,241

(22) PCT Filed: Feb. 5, 2021
(86) PCT No.: PCT/AU2021/050094

§ 371 Date: Aug. 5, 2022

(30) Foreign Application Priority Data
Feb. 7, 2020 (AU) 2020900347
Mar. 6, 2020 (AU) 2020900699
Jun. 19, 2020 (AU) 2020902038
Nov. 30, 2020 (AU) 2020904441

(51) Int. Cl. C22B 34/22; C22B 7/04; C22B 3/22; C22B 3/42; C22B 3/12; C22B 7/00

(52) U.S. Cl. CPC C22B 34/22; C22B 7/04; C22B 3/22; C22B 3/42; C22B 3/12; C22B 7/008

(57) ABSTRACT

A method for the recovery of vanadium from a vanadium containing feed stream, the method comprising the steps of: subjecting the vanadium feed stream to a leach step, the leach step comprising contacting the vanadium feed stream with an alkaline carbonate leach solution to form a leach slurry comprising a pregnant leach solution containing vanadium and a solid residue; passing the leach slurry to a solid/liquid separation step to produce a pregnant leach solution containing vanadium; and recovering a vanadium product from the pregnant leach solution.

### TECHNICAL FIELD

The present invention relates to a method for the recovery of vanadium from alkaline feedstocks, particularly secondary materials such as steel slags. More specifically, the method of the present invention is adapted to recover vanadium from such feedstocks through hydrometallurgical processing.

### BACKGROUND ART

The following discussion of the background art is intended to facilitate an understanding of the present invention only. The discussion is not an acknowledgement or admission that any of the material referred to is or was part of the common general knowledge as at the priority date of the application.

Vanadium is most prominently found within magnetite iron ore deposits and is typically present in slags generated during iron recovery processes. To extract or recover vanadium, the concentrates or slags are typically processed with the so-called ‘salt roast process’. In the salt roast process, the vanadium slag is mixed with one or more alkali salts and subjected to a roast typically at 800-900° C., to produce sodium metavanadate. These vanadium values are subsequently and selectively leached with water. Vanadium values are then recovered in a refining process that includes precipitation from the leach solution as ammonium metavanadate or ammonium polyvanadate, both of which can be treated at high temperature to de-ammoniate and convert to product vanadium pentoxide. The process and particularly the initial high temperature salt roast step is highly energy intensive and so the vanadium tenor in the feed needs to be at a particular level to make the process economical.

A number of alternative hydrometallurgical processes have been employed to process the slags for the recovery of vanadium. Such processes typically comprise an acid leach step in order to extract vanadium into solution. The main issue faced with the recovery of vanadium by hydrometallurgical means is that other metals species, such as iron, titanium, calcium, magnesium and silica, are typically co-extracted with the vanadium during the acid leach step. The presence of these species in the leach solution must be accounted for when recovering vanadium from the leach solution. The separation of vanadium from a leach solution that also contains dissolved iron species poses a significant challenge. Most processes by which this can be achieved are economically challenging. Both vanadium and iron can be found in multiple oxidation states and degrees of coordination with varying leach systems and the mixture of species containing these elements alone can be quite complex. As a consequence, many traditional separation techniques and established reagents are unable to efficiently separate vanadium from iron. In order to address this problem, most processes require that the leach solution is first treated to remove these impurities, particularly iron and titanium, before vanadium can be recovered. This adds complexity and overall cost to processes.

CaO and other alkaline materials are also commonly found in slag materials. Consequently a further problem with the use of an acid leach on these materials is the high consumption of acid as a result of the high alkaline content. Furthermore, when sulphuric acid is used as the leachate, a byproduct of the leach is solid CaSO₄.xH₂O which forms at large volumes. Along with final effluent neutralization solids this product must be adequately disposed of.

Basic or alkaline leach systems for the recovery of vanadium from such feedstocks has not been widely applied to industry. The main complications of such systems appears to be the recovery being limited by the poor liberation of vanadium from the feedstock.

Throughout this specification, unless the context requires otherwise, the word “comprise” or variations such as “comprises” or “comprising”, will be understood to imply the inclusion of a stated integer or group of integers but not the exclusion of any other integer or group of integers.

### SUMMARY OF INVENTION

In accordance with a first aspect of the present invention, there is provided a method for the recovery of vanadium from a vanadium containing feed stream, the method comprising the steps of:
subjecting the vanadium feed stream to a leach step, the leach step comprising contacting the vanadium feed stream with an alkaline carbonate leach solution to form a leach slurry comprising a pregnant leach solution containing vanadium and a solid residue;
passing the leach slurry to a solid/liquid separation step to produce a pregnant leach solution containing vanadium; and
recovering a vanadium product from the pregnant leach solution.

The inventors have found that the alkaline carbonate leach of the present invention demonstrates good selectivity of vanadium over other metals and silica that may be found in the feedstock.

Throughout this specification, unless the context requires otherwise, the term “alkaline carbonate leach solution” or similar variations, will be understood to refer to an aqueous solution comprising a carbonate or bicarbonate of an alkali metal or a carbonate or bicarbonate of an alkaline earth metal.

The method of present invention has been found to be suitable for use on alkaline feedstocks. It is envisaged that the present invention may be used to recover vanadium from a range of different sources, including slags, residues and other by-products of industrial processes. Throughout this specification, unless the context requires otherwise, the term “alkaline feedstock” will be understood to refer to feedstocks that comprise one or more alkali metal compounds and alkaline earth metal compounds or form an alkaline solution or slurry when mixed with water.

The method of the present invention is preferably adapted to recover vanadium products from slag materials that result from the steel industry. In addition to vanadium, such materials will contain iron, along with other species such as manganese titanium and chromium. The method of the present invention allows for vanadium to be leached from such materials with high selectivity over other impurity metals. This has been found to simplify the subsequent recovery of vanadium from the pregnant leach solution.

In one form of the present invention, the vanadium containing feed stream comprises a steel slag. Throughout this specification, unless the context requires otherwise, the term “steel slag” will be understood to refer to the slag byproduct of a steel manufacturing process. As would be appreciated by a person skilled in the art, when an iron containing material is exposed to high temperatures, at least some impurities or gangue material are separated from the molten metal and are removed as a slag. This slag is subsequently cooled, and a solid material is formed.

In one form of the present invention, the alkaline carbonate leach solution comprises one or more of sodium carbonate (Na₂CO₃), sodium bicarbonate (NaHCO₃) and sodium hydroxide (NaOH). In one form of the present invention, the alkaline carbonate leach solution comprises one or more of potassium carbonate (K₂CO₃), potassium bicarbonate (KHCO₃) and potassium hydroxide (KOH). Any reference to sodium salts or species throughout the specification should be understood to be analogous to the use of potassium salts or species and any other alkali or alkaline earth carbonates and bicarbonates or mixtures thereof. As would be appreciated by a person skilled in the art, carbonates, bicarbonates and hydroxides exist together in aqueous solutions in a dynamic equilibrium in in the leach solution during the leach step. In strongly basic conditions, the hydroxide and carbonate ion predominates, while in weakly basic conditions the bicarbonate ion is more prevalent.

In one form of the present invention, the alkaline carbonate leach solution comprises ammonium carbonate.

In one form of the present invention, the leach step is conducted under oxidative conditions. Preferably, the leach step is conducted in the presence of an oxidant. More preferably, the oxidant is selected from oxygen, air, and hydrogen peroxide. Alternatively, the feedstock is combined with an oxidant prior to the leach step. Suitable oxidants include MnO₂. In an alternative form of the present invention, no oxidant is added to the leach step.

In one form of the present invention, an oxidant is added to the leach step. Preferably, the addition of the oxidant will target a solution Eh of >−100 mV against a Ag/AgCl reference electrode.

In one embodiment of the present invention, the method further comprises the step of:
subjecting the feed stream to a pretreatment process,
   prior to the step of subjecting the feed stream to the leach step.

Preferably, the pre-treatment process comprises one or more size reduction steps. More preferably, the one or more size reduction steps comprise one or more of a crushing step, a grinding step and a milling step.

In one form of the present invention, the pre-treatment process comprises one or more beneficiation steps. Preferably, the one or more beneficiation steps include one or more of a gravity classification step, a magnetic classification step and a flotation step.

In one form of the present invention, the feed stream is subjected to a pre-leach step, prior to the leach step. Preferably, the pre-leach step comprises the contact of the feed stream with an alkaline liquor to produce a pre-leach slurry. In one form of the present invention, the alkaline liquor is an alkaline carbonate leach solution. Preferably, the alkaline liquor comprises sodium carbonate and/or sodium bicarbonate. In one form of the present invention, the alkaline liquor comprises sodium hydroxide. In one form of the present invention the alkaline liquor comprises potassium carbonate and/or potassium bicarbonate. In one form of the present invention, the alkaline liquor comprises potassium hydroxide. In one form of the present invention, at least a portion of the alkaline liquor may be supplemented by recycle streams. As discussed above, carbonates, bicarbonates and hydroxides exist together in aqueous solutions in a dynamic equilibrium. It is envisaged that all three will be present in varying proportions in the alkaline leach solution.

In one form of the present invention, the pre-leach step is conducted after the feedstock has been subjected to one or more size reduction steps. In one form of the present invention, the pre-leach slurry is subjected to one or more size reduction steps.

In one form of the present invention, a carbon dioxide stream is injected into the pre-leach step.

In one form of the present invention, the step of:
subjecting the feed stream to a leach step to form a slurry including a pregnant leach solution that comprises dissolved vanadium and a solid residue,
   more specifically comprises subjecting the feed stream to a leach step in one or more leach reactors. Preferably, the step comprises subjecting the feed stream to a leach step in two or more leach reactors. More preferably, the step comprises subjecting the feed stream to a leach step in three or more leach reactors. More preferably, the step comprises subjecting the feed stream to a leach step in four or more leach reactors. More preferably, the step comprises subjecting the feed stream to a leach step in five or more leach reactors.

In one form of the present invention, the step of subjecting the feed stream to a leach step is conducted at atmospheric pressure. In one form of the present invention, the step of subjecting the feed stream to a leach step is conducted at elevated pressure.

In one form of the present invention, the step of subjecting the feed stream to a leach step is conducted at ambient temperature. In one form of the present invention, the step of subjecting the feed stream to a leach step is conducted at elevated temperature.

In one form of the present invention, the leach step is conducted at pH above 7.5.

In one form of the present invention, the pH of the leach step in controlled. Preferably, the leach step is maintained at a pH between 7.5 and 14. More preferably, the leach step is maintained at a pH between 9 and 10.

In one form of the present invention, a carbon dioxide stream is injected into the leach step. Preferably, the carbon dioxide stream is used to control the pH of the leach step. Alternatively, carbonic acid may be added to the leach step.

In an alternative form of the present invention, the leach step is conducted until the carbonate concentration is reduced to a target concentration. Preferably, the target concentration is below 5 g/L.

In one form of the present invention, at least a portion of the leach slurry is subjected to a size reduction step. In one form of the present invention, the size reduction step is conducted during the leach step. In an alternative form of the present invention, at least a portion of the leach slurry is transferred to a size reduction step to produce a process stream with a reduced particle size. In one form of the present invention, the process stream is returned to the leach step. In an alternative form of the present invention, the process stream is subjected to a secondary leach step. Preferably, the secondary leach step comprises contacting the process stream with an alkaline carbonate leach solution to form a secondary leach slurry comprising a pregnant leach solution containing vanadium and a solid residue. In one form of the present invention, the secondary leach step is conducted in the presence of an oxidant. In one form of the present invention, a carbon dioxide stream is injected into the secondary leach step. In one form of the present invention, the secondary leach slurry is directed to the solid liquid separation step to recover a pregnant leach solution. Preferably, the solid residue is subjected to one or more further size reduction steps, where each size reduction step is followed by a further leach step.

In an alternative form of the present invention, the tertiary leach solution is subjected to one or more further size reduction steps, where each size reduction step is followed by a further leach step. In one form of the present invention, the secondary leach slurry is subjected to a size reduction step to produce a process stream with a reduced particle size. In one form of the present invention, the process stream is subjected to a tertiary leach step. Preferably, the tertiary leach step comprises contacting the process stream with an alkaline carbonate leach solution to form a tertiary leach slurry comprising a pregnant leach solution containing vanadium and a solid residue. In one form of the present invention, the tertiary leach slurry is directed to the solid liquid separation step to recover a pregnant leach solution. In an alternative form of the present invention, the tertiary leach solution is subjected to one or more further size reduction steps, where each size reduction step is followed by a further leach step.

In one form of the present invention, the leach slurry is directed to a classification apparatus with the overflow being directed to the solid liquid separation step and the underflow being recycled back to the leach step, the pre-leach step or the size reduction step.

In one form of the present invention, the solid/liquid separation step comprises the treatment of the slurry in a filtration apparatus. In one embodiment, the solid/liquid separation step comprises a thickening apparatus upstream of the filtration apparatus.

In an alternative form of the present invention, the solid/liquid separation step comprises the treatment of the slurry in a counter current decantation (CCD) circuit. In one embodiment, the CCD circuit comprises two or more thickeners arranged in series.

In one form of the present invention, the solids recovered in the solid liquid separation step are subjected to a tertiary leach step to further extract vanadium. Preferably, the tertiary leach step comprises the contact of the solid with an alkaline solution. More preferably, the tertiary leach step comprises the contact of the solid with an alkaline carbonate solution. In one form of the present invention, a carbon dioxide stream is injected into the tertiary leach step.

In one form of the present invention, the step of recovering a vanadium product from the pregnant leach solution comprises precipitating a vanadium rich solid and separating the vanadium rich solid from the barren leach solution. Throughout the specification, the term “barren leach solution” will be understood to refer to a leach solution to which at least a portion of the vanadium has been recovered. It should be understood to include a solution that contains vanadium.

In an alternative form of the present invention, the step of recovering a vanadium product from the pregnant leach solution comprises contacting the pregnant leach solution with an ion exchange medium to selectively recover vanadium and separate it from the barren leach solution.

In an alternative form of the present invention, the step of recovering a vanadium product from the pregnant leach solution comprises contacting the pregnant leach solution with an organic solution comprising a vanadium extractant and subsequently separating the loaded organic solution from the barren leach solution. Preferably, the loaded organic solution is contacted with a scrub solution. In one form of the present invention, vanadium is recovered from the loaded organic solution with a strip solution. Preferably, the strip solution is sodium hydroxide or potassium hydroxide.

In embodiments where an organic solution comprising a vanadium extractant is used to recover vanadium from the pregnant leach solution, the present invention further comprises the step of recovering vanadium products from the strip solution. In one embodiment, the recovery of vanadium products comprises precipitating a vanadium rich solid and separating the vanadium rich solid from the barren strip solution.

In an alternative form of the present invention, the step of recovering a vanadium product from the pregnant leach solution comprises passing the pregnant leach solution through a nanofiltration system in which the bicarbonate ion is preferentially removed from the vanadium species. Preferably, the bicarbonate stream is returned to the leach step.

In an alternative form of the present invention, the step of recovering a vanadium product from the pregnant leach solution comprises passing the pregnant leach solution to a crystallisation circuit where the sodium carbonate and/or bicarbonate salts are selectively crystalised over vanadium species. Preferably, the crystallisation circuit comprises one or more crystallisation stages. In one form of the present invention, the crystalised solids are removed and recycled to the leach step.

In forms of the present invention where the leach step is conducted until the carbonate concentration is reduced to a target concentration, the step of recovering a vanadium product from the pregnant leach solution preferably comprises passing the pregnant leach solution to a crystallisation circuit where vanadium species are selectively crystalised.

A barren leach solution results from the step of recovering a vanadium product from the pregnant leach solution. In one form of the present invention, at least a portion of the barren leach solution is recycled to the leach step. In one form of the present invention, the barren leach solution is carbonated prior to being recycled to the leach step. In embodiments where the leach step is conducted in the presence of a carbon dioxide stream, the barren leach solution may be directly recycled to the leach step.

In one form of the present invention, at least a portion of the barren leach solution is recycled to the pre-leach step. Preferably, the barren leach solution is used to supplement at least a portion of the alkaline carbonate leach solution. In one form of the present invention, the barren leach solution is carbonated prior to being recycled to the pre-leach step.

In one form of the present invention, at least a portion of the barren leach solution is recycled to the secondary or tertiary leach step. Preferably, the barren leach solution is used to supplement at least a portion of the alkaline carbonate leach solution. In one form of the present invention, the barren leach solution is carbonated prior to being recycled to the tertiary leach step.

In one form of the present invention, the barren leach solution is used a wash water in a solid liquid separation step.

In one form of the present invention, the barren leach solution is used in the feed or intermediate size reductions step.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a flowsheet of the method of the present invention,

FIG. 2 is flowsheet of an alternative embodiment of the present invention which incorporates the recycle of a carbon dioxide stream from an external source;

FIG. 3 is a flowsheet of an alternative embodiment of the present invention which incorporates the recycle of a carbon dioxide stream from the leach residue;

FIG. 4 is a flowsheet of an alternative embodiment of the present invention which does not regenerate carbonates in the leach step;

FIG. 5 is a flowsheet of an alternative embodiment of the present invention;

FIG. 6 is a flowsheet of an alternative embodiment of the present invention which incorporates a single leach step;

FIG. 7 is a flowsheet of an alternative embodiment of the present invention which incorporates a solvent extraction step;

FIG. 8 is a graphical representation of the results of a trial undertaken to determine the effect of grind size on vanadium extraction;

FIG. 9 is a graphical representation of the results of a trial undertaken to determine the effect of temperature on vanadium extraction;

FIG. 10 is a graphical representation of the results of a trial undertaken to determine the effect of sodium carbonate concentration on vanadium extraction;

FIG. 11 is a graphical representation of the results of a trial undertaken to determine the effect of percent solids on vanadium extraction;

FIG. 12 is a graphical representation of the results of a trial undertaken to determine the effect of the addition of an oxidant on vanadium extraction;

FIG. 13 is a graphical representation of the results of a trial undertaken to determine the extraction of vanadium during a secondary leach;

FIG. 14 is a graphical representation of the results of a trial undertaken to determine the extraction of vanadium during a tertiary leach;

FIG. 15 is a graphical representation of the results of a trial undertaken to determine the extraction of vanadium in a sequential leaching process;

FIG. 16 is a graphical representation of the results of a trial undertaken to determine the extraction of vanadium from a synthetic leach solution using an organic extractant; and

FIG. 17 is a graphical representation of the results of a trial undertaken to determine the extraction of vanadium from a recovered leach solution using an organic extractant.

### DESCRIPTION OF EMBODIMENTS

The method of the present invention relates to the recovery of vanadium from a vanadium containing feed stream. In a very broad sense, the method comprises the steps of:
subjecting the vanadium feed stream to a leach step, the leach step comprising contacting the vanadium feed stream with an alkaline carbonate leach solution to form a leach slurry comprising a pregnant leach solution containing vanadium and a solid residue;
passing the leach slurry to a solid/liquid separation step to produce a pregnant leach solution containing vanadium;
recovering a vanadium product from the pregnant leach solution.

The inventors have found that the carbonate leach of the present invention demonstrates good selectivity of vanadium over other metals that may be found in the feedstock.

The method of present invention has been found to be suitable for use on alkaline feedstocks. The presence of alkaline material in feedstocks presents a problem for the treatment of such feedstocks by hydrometallurgical processes that use acids as the primary leachant. The main disadvantage with such processes is that a high amount of acid is consumed by the alkaline material, which increases the operating costs. Furthermore, acid soluble impurities are also extracted into the leach solution and further processing is required to remove these. In addition, large volumes of calcium salts, leach residues and/or effluent neutralization wastes can be generated and the handling of these leads to process inefficiencies and/or added processing costs.

It is envisaged that the present invention may be used to recover vanadium from a range of different sources, including slags, residues and/or other by-products of industrial processes.

The method of the present invention is preferably adapted to recover vanadium products from slag materials that result from the steel industry. In addition to vanadium, such materials will contain iron, along with other species such as titanium. The method of the present invention allows for vanadium to be leached from such materials with high selectivity over other impurity metals. This has been found to simplify the recovery of vanadium from the pregnant leach solution.

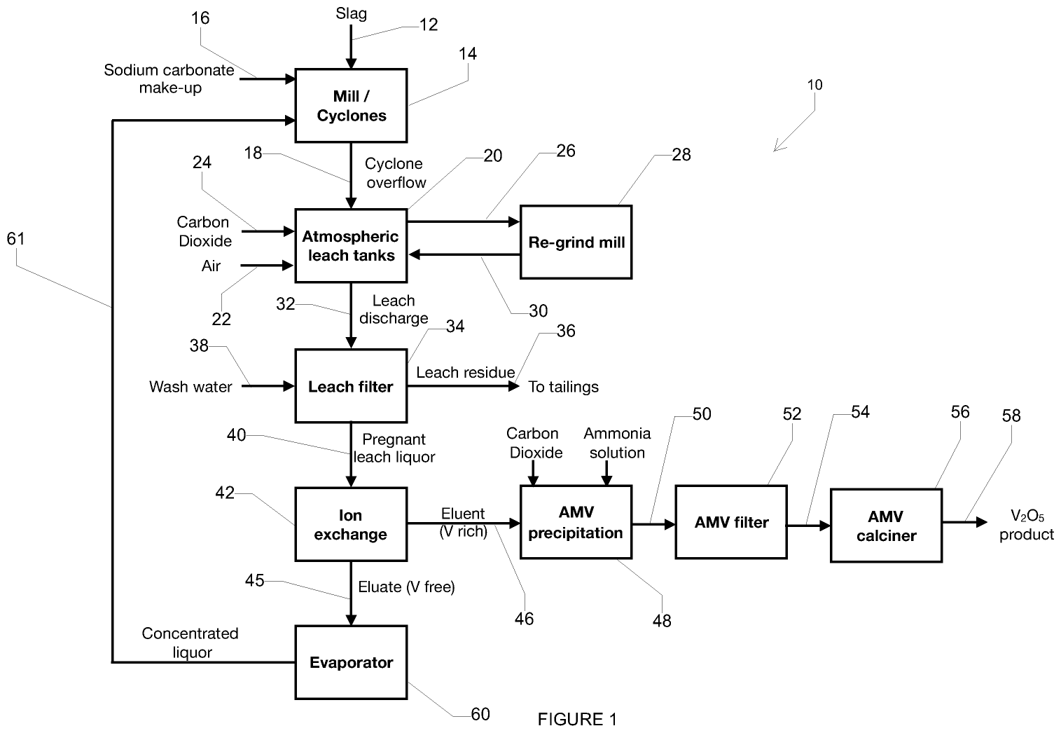

In FIG. 1, there is shown a method for the recovery of vanadium 10 from a feed stream 12 in accordance with an embodiment of the present invention. It is envisaged that the feed stream 12 may be subjected to one of more size reduction steps (not shown) prior to being processed. The feedstock 12 should have a target particle size of <200 μm, with a target particle size of <100 μm being preferred and <75 μm being more preferable. It is envisaged that conventional crushing and grinding apparatus available to those skilled in the art can be used to reduce the particle size of the feedstock 12. The feedstock may be subjected to one or more beneficiation steps (not shown) to remove excess low value bearing components of the feedstock 12. As discussed previously, the one or more beneficiation steps can include one or more of a gravity classification step, a magnetic classification step and a flotation step. The inventors have found that a significant proportion of the vanadium in steel slags may be captured in silica glass. The one or more size reduction steps have been found to liberate vanadium from such materials, allowing for subsequent dissolution in the leach step. It is envisaged that both wet and dry particle size reduction apparatus may be utilised.

In the embodiment shown in FIG. 1, the feedstock 12 is directed to a pre-leach step 14 where it is contacted with an alkaline liquor 16 and recycled process water (such as loaded wash solution) to form a pre-leach slurry 18. The alkaline liquor 16 will preferably comprise sodium hydroxide, along with sodium carbonate and/or sodium bicarbonate. The alkaline liquor 16 may be supplemented by recycle liquor 61 (discussed below), which will preferably contain sodium carbonate/sodium bicarbonate and sodium hydroxide. The contact of the feedstock 12 with the alkaline liquor 16 will begin the extraction of vanadium from the feedstock 12 into solution. The extent of this leaching will be dependent on the alkaline liquor 16, the vanadium grade in the feedstock 12 and feedstock particle size.

In one embodiment, the pre-leach step 14 is conducted in a leach vessel.

In an alternative form of the invention, the pre-leach step 14 may be conducted in wet milling apparatus. As would be appreciated by a person skilled in the art, wet milling apparatus break solid materials into smaller pieces by grinding, cutting or crushing. Suitable milling apparatus include ball mills, rod mills, autogenous grinding (AG) mills, and semi-autogenous grinding (SAG) mills. It is envisaged that by conducting the pre-leach step 14 in a wet milling apparatus, more intimate contact between the feedstock 12 and the alkaline liquor 16 may be achieved and effective contact time increased, leading to further extraction.

The pre-leach slurry 18 may be directed to a wet classification apparatus, such as a cyclone apparatus, to prevent oversize particles from being transferred from the pre-leach step 14. In such an embodiment, oversize particles could be returned to the pre-treatment mill while undersize particles progress in the leaching circuit.

### Pre-Leach Conditions

In one embodiment, the pre-leach is conducted at ambient temperature. In one embodiment, the pre-leach is conducted at elevated temperature. Preferably, the pre-leach is conducted at a temperature above 40° C.

In one embodiment, the pre-leach step is conducted at ambient pressure. In one embodiment, the pre-leach step is conducted at elevated pressure.

In one embodiment, the pulp density of the pre-leach step is 10-50%. More preferably, the pulp density in the pre-leach step is 20-40%.

In one embodiment, the Na₂CO₃/NaHCO₃ concentration in the alkaline carbonate leach solution is between 2-35%. More preferably, the Na₂CO₃/NaHCO₃ concentration in the alkaline carbonate leach solution is between 10-25%.

### Leach

The pre-leach slurry 18 is directed to leach step 20. In leach step 20, the pre-leach slurry is contacted with an alkaline carbonate leach solution to extract vanadium into the solution. As discussed above, an alkaline carbonate leach solution will preferably be used in the pre-leach step. However, where an alkaline liquor, such as sodium hydroxide, is used in the pre-leach step 14, a carbonate source will need to be introduced into leach step 20. It is envisaged that the carbonate may be generated in-situ by the addition of carbon dioxide.

It is envisaged that in certain embodiments, the pre-leach step 14 may not be required and feedstock 12 may be directly transferred to the leach step 20. In such embodiments, an alkaline carbonate leach solution (not shown) is directed to the leach step 20 to contact the feedstock 12. Depending on the precise feed material being used, the vanadium species in the feed may exist in a number of different forms. For example, calcium vanadate species may include Ca(VO₃)₂, CaV₂O₆.3H₂O, CaV₂O₆.4H₂O, CaV₆O₁₆.9H₂O, Ca₂V₂O₇.9H₂O, Ca₃V₁₀O₂₈.16H₂O, amongst others. By way of illustration, the calcium vanadates in the feedstock may react with the alkaline liquor 16 in the leaching process according to the following reactions:

Ca(VO₃)₂+M₂CO₃=CaCO₃+2MVO₃

Ca₂V₂O₇+2M₂CO₃=CaCO₃+M₄V₂O₇

(where M is an alkaline metal or alkaline earth metal)

It would be appreciated by a person skilled in the art the above reactions are included for illustration purposes only and are not an exhaustive list of the reactions occurring during the leach step 20.

Additional alkaline liquor or alkaline carbonate leach solution may be directed into leach step 20 to increase the CO₃²⁻/HCO₃⁻ concentration in the leach solution. Alternatively, CO₃²⁻/HCO₃⁻ may be regenerated in the solution.

An oxidant stream 22 may be injected into the leach step 20 to oxidise at least a portion of the components of the pre-leach slurry and improve vanadium recovery. Without wishing to be bound by theory, it is believed that at least some of the vanadium in the feedstock may be encapsulated in various Fe(II) compounds found in the feedstock. The inventors have found that the addition of the oxidant will oxidise Fe(II) to Fe(III) which can assist in the liberation of vanadium from within these compounds. Furthermore, any dissolved Fe(III) will likely re-precipitate as FeO(OH) (also written as Fe₂O₃·H₂O). In one embodiment, the oxidant is selected from hydrogen peroxide and potassium permanganate.

In the embodiment shown in FIG. 1, a carbon dioxide stream 24 is directed into the leach step 20. As would be appreciated by a person skilled in the art, alkaline feedstocks such as steel slags contain a high CaO and Ca(OH)₂ content. The Na₂CO₃/NaHCO₃ in the leach liquor will react with CaO/Ca(OH)₂ to produce solid CaCO₃ and NaOH. The reactions can be summarized by the following simplified reactions:

CaO+Na₂CO₃+H₂O→CaCO₃+2NaOH

CaO+NaHCO₃→CaCO₃+NaOH

Ca(OH)₂+Na₂CO₃2NaOH+CaCO₃

Ca(OH)₂+NaHCO₃→CaCO₃+NaOH+H₂O

The inventors have found that carbon dioxide will react with sodium hydroxide and other species in the leach solution to form a reactive carbonate system as represented by the following simplified reactions:

H₂O+CO₂→H₂CO₃

NaOH+CO₂→NaHCO₃

2NaOH+CO₂→Na₂CO₃+H₂O

Na₂CO₃+H₂O+CO₂→+2NaHCO₃

The addition of carbon dioxide has therefore been found to regenerate Na₂CO₃/NaHCO₃ in the leach solution from the NaOH produced during the reaction of CaO, allowing for further extraction of vanadium from the feedstock.

Carbon dioxide may be obtained from a range of sources. In one embodiment, at least a portion of the carbon dioxide is captured from the atmosphere. In one embodiment, at least a portion of the carbon dioxide is captured from waste gas streams. Preferably, the waste gas stream is a blast furnace off-gas. In one embodiment, at least a portion of the carbon dioxide is captured from calciner off-gas. Preferably, the carbon dioxide is captured from the calcination of limestone.

In one form of the present invention, the carbon dioxide is directly captured from one or more sources. In an alternative form of the present invention, the carbon dioxide is captured by an intermediary agent in a sorption process and carbon dioxide is subsequently regenerated from the intermediary agent. It is envisaged that the transfer of CO₂ from an intermediary agent could be by chemical or thermal desorption. This is particularly useful when capturing CO₂ from the atmosphere or exhaust gas streams.

In one embodiment, the carbon dioxide is subjected to an impurity removal step. In one embodiment the purified gas stream is used directly as the source of carbon dioxide.

In one embodiment carbon dioxide is concentrated before use. The concentration of carbon dioxide in the gas stream is preferably >20%. More preferably the carbon dioxide in the gas stream is >90%.

In one embodiment, the pH of the leach solution is controlled throughout the leach step. In one embodiment, the leach solution is maintained at a pH above 7.5. In one embodiment, the leach solution is maintained at a pH above 8. In one embodiment, the leach solution is maintained at a pH above 8.5. In one embodiment, the leach solution is maintained at a pH above 9.

In one embodiment, the leach solution is maintained at a pH between 7.5 and 14. In one embodiment the pH is maintained between 8 and 11. In one embodiment, the pH is maintained between 9 and 10. The inventors have found that the pH of the leach solution will naturally increase throughout the leach process as a result of the formation of NaOH during the reaction of the alkaline carbonates and CaO/Ca(OH)₂. However, at pH above 14 silica is increasingly soluble and will be leached into solution. It has also been found that at pH below 9, small quantities of impurities such as manganese, magnesium, iron and titanium begin to dissolve. This will increase the complexity and may impact the subsequent recovery of vanadium form the leach solution. By maintaining a pH between 9 and 14, vanadium extraction can be achieved with minimal silica being leached into solution.

In one embodiment, the pH is maintained by the addition of carbon dioxide into the leach solution. As discussed above, carbon dioxide will convert NaOH to Na₂CO₃/NaHCO₃. Alternatively, the pH is maintained by the addition of acid.

In a preferred embodiment, the leach step 20 is conduct at a pH of approximately 10 to prevent the above discussed impurities leaching into solution. Following separation of undissolved solids, the pH of the pregnant leach solution may then be lowered to between 9-9.5 in order to precipitate at least some silica out of the solution. A coagulant may be added to assist in the silica removal. The precipitated solids may then be filtered out of the solution.

The leach step 14 preferably comprises a leach circuit comprising one or more leach vessels arranged in series.

### Leach Conditions

In one embodiment, the feedstock has a particle size of P₈₀ 106 μm. In one embodiment, the feedstock has a particle size of P₈₀ 75 μm. In one embodiment, the feedstock has a particle size of P₈₀ 53 μm. In one embodiment, the feedstock has a particle size of P₁₀₀ 25 μm.

In one embodiment, the leach is conducted at ambient temperature. In one embodiment, the leach is conducted at elevated temperature. Preferably, the leach step is conducted at a temperature up to boiling point. In one embodiment, the leach step is conducted at a temperature above 50° C. In one embodiment, the leach step is conducted at a temperature above 60° C. In one embodiment, the leach step is conducted at a temperature above 70° C. In one embodiment, the leach step is conducted at a temperature above 80° C. In one embodiment, the leach step is conducted at a temperature above 90° C.

In one embodiment, the leach step is conducted at ambient pressure. In one embodiment, the leach step is conducted at elevated pressure. It is envisaged that carbon dioxide may be injected into the headspace of the leach reactor.

In one embodiment, the pulp density of the leach step is 10-50%. In one embodiment, the pulp density is 20-40%

In one embodiment, the Na₂CO₃/NaHCO₃ concentration in the leach solution is between 2-35%. In one embodiment, the Na₂CO₃/NaHCO₃ concentration in the leach solution is at least 50 g/L. In one embodiment, the Na₂CO₃/NaHCO₃ concentration in the leach solution is at least 75 g/L. In one embodiment, the Na₂CO₃/NaHCO₃ concentration in the leach solution is at least 125 g/L.

In embodiments where carbon dioxide is sparged through the leach vessel, the Na concentration in the leach solution is at least 40 g/L.

In one embodiment, the resonance time of the leach step is greater than 1 hour. In one embodiment, the resonance time of the leach step is greater than 2 hours. In one embodiment, the resonance time of the leach step is greater than 3 hours. In one embodiment, the resonance time of the leach step is greater than 4 hours. In one embodiment, the resonance time of the leach step is greater than 5 hours. In one embodiment, the resonance time of the leach step is greater than 6 hours. In one embodiment, the resonance time of the leach step is greater than 7 hours. In one embodiment, the resonance time of the leach step is greater than 8 hours. In one embodiment, the resonance time of the leach step is greater than 9 hours. In one embodiment, the resonance time of the leach step is greater than 10 hours. In one embodiment, the resonance time of the leach step is greater than 11 hours. In one embodiment, the resonance time of the leach step is greater than 12 hours.

In one embodiment, a solution Eh of >−100 mV against a Ag/AgCl reference electrode is maintained. In one embodiment, a solution Eh of >−90 mV against a Ag/AgCl reference electrode is maintained. In one embodiment, a solution Eh of >−80 mV against a Ag/AgCl reference electrode is maintained. In one embodiment, a solution Eh of >−70 mV against a Ag/AgCl reference electrode is maintained. In one embodiment, a solution Eh of >−60 mV against a Ag/AgCl reference electrode is maintained. In one embodiment, a solution Eh of >−50 mV against a Ag/AgCl reference electrode is maintained. In one embodiment, a solution Eh of >−40 mV against a Ag/AgCl reference electrode is maintained. In one embodiment, a solution Eh of >−30 mV against a Ag/AgCl reference electrode is maintained. In one embodiment, a solution Eh of >−20 mV against a Ag/AgCl reference electrode is maintained. In one embodiment, a solution Eh of >−10 mV against a Ag/AgCl reference electrode is maintained. In one embodiment, a solution Eh of >0 mV against a Ag/AgCl reference electrode is maintained. In one embodiment, a solution Eh of >50 mV against a Ag/AgCl reference electrode is maintained. In one embodiment, a solution Eh of >100 mV against a Ag/AgCl reference electrode is maintained. In one embodiment, a solution Eh of >200 mV against a Ag/AgCl reference electrode is maintained. In one embodiment, a solution Eh of >300 mV against a Ag/AgCl reference electrode is maintained. In one embodiment, a solution Eh of >400 mV against a Ag/AgCl reference electrode is maintained.

### Regrind Circuit

In one embodiment, a portion of the leach slurry 26 is directed to a size reduction step 28. In size reduction step 28, the slurry is treated to reduce the particle size of the solids in the leach slurry 26. The treated stream 30 exiting the size reduction step 28 is directed back to the leach step 20. It is envisaged that the treated stream may also be directed to a secondary leach step (not shown).

As discussed above, Na₂CO₃ and NaHCO₃ will react with CaO to form solid CaCO₃. Without wishing to be bound by theory, the inventors understand that these species will react with CaO at the exposed surfaces of the feedstock particles or with Ca²⁺ in solution to form solid CaCO₃. At least some of the precipitated CaCO₃ will form as a coating on the feedstock, thereby hindering further leaching of the vanadium. The inventors have found that by subjecting the coated (partially leached) feedstock to a size reduction step 28, at least a portion of the CaCO₃ may be removed, exposing the surface of the feedstock and allowing further leaching of the vanadium.

It is envisaged that any suitable milling apparatus may be used in size reduction step 28. Examples of suitable apparatus include ball mills, rod mills, autogenous grinding (AG) mills, semi-autogenous grinding (SAG) mills, stirred media mills and stirred media detritors.

In the embodiment shown in FIG. 1, the size reduction step 28 is performed in parallel with the leach step 20, where a portion of the leach slurry is bled from the leach step 20 and directed to the size reduction step 28 and then recycled back to the leach step 20. It is envisaged that the exact arrangement of the size reduction step 28 will be impacted by the particular leach circuit utilised in leach step 20. For example, if multiple leach vessels are arranged in series, it is envisaged that the underflow of the final leach vessel, for example, may be directed to the size reduction step 28, with the treated stream 30 being returned to an earlier leach vessel. In this manner, the solid particles in the treated stream 30 are provided with sufficient resonance time in the leach step 20 to enable increased vanadium extraction. In an alternative embodiment, the treated stream 30 may be directed to a secondary leach step (not shown), where it is contacted with fresh or regenerated carbonate liquor to further extract vanadium. It is envisaged that the secondary leach step would be conducted under similar conditions to leach step 20 and that both an oxidant stream and a carbon dioxide stream may be injected into the leach vessel. An advantage of this embodiment is that the resonance time of the treated stream 30 in the secondary leach step can be accurately controlled to ensure maximum recovery. In a still alternative embodiment, the leach step 20 may be conducted in wet milling apparatus. In this embodiment, the formed CaCO₃ solid is continuously removed from the surface of the feedstock.

In one embodiment, the size reduction step reduces the particle size to P₈₀ 38 μm. In one embodiment, the size reduction step reduces the particle size to P₉₅ 38 μm. In one embodiment, the size reduction step reduces the particle size to P₈₀ 10 μm.

The leach slurry 32 exiting leach step 20 comprises a pregnant leach solution containing dissolved vanadium and a solid residue. The leach slurry 32 is directed to a solid liquid separation step 34 to remove a solid residue steam 36. Wash water 38 is used in the solid liquid separation step 34 to ensure entrained liquids are fully separated from the solid residue 36. Recycle liquor 61 may be used as the wash water 38 in the first wash. The solid residue stream is preferably directed to tailings. It is envisaged that the solid liquid separation step 34 will be conducted in a filtration apparatus, such as belt filter. Alternative solid liquid separation devices may be utilised in solid liquid separation step 34. It is envisaged that a pre-filter thickener may also be used.

In one embodiment, a counter-current washing process is used in the solid liquid separation step 34 in order to maximise vanadium recovery.

In one embodiment, the pH of the pregnant leach solution 40 is adjusted prior to the recovery of vanadium products. In one embodiment, the pH is adjusted to 8.5-9.5. In one embodiment, the pH is adjusted to 9.0-9.5. The pH adjustment can be done with CO₂ or addition of a small quantity of acid.

In one embodiment, the pregnant leach solution 40 is directed to a concentration step (not shown). In the concentration step, the concentration of vanadium in the pregnant leach solution is increased. Preferably, the concentration step is conducted prior to the pregnant leach solution 40 being directed to vanadium recovery circuit 42.

In one embodiment, the pregnant leach solution 40 is directed to a purification step (not shown). In the purification step, one or more impurities are removed from the pregnant leach solution 40. Preferably, the purification step comprises passing the pregnant leach solution 40 through a nano-filtration/membrane system. Preferably, the purification step is conducted prior to the pregnant leach solution 40 being directed to vanadium recovery circuit 42.

In one embodiment, the concentration step and purification step are conducted concurrently.

The pregnant leach solution 40 is directed to a vanadium recovery circuit 42 to extract vanadium products from the pregnant leach solution 40. It is envisaged that a number of different recovery means may be employed in the vanadium recovery circuit 42. In the embodiment shown in FIG. 1, the pregnant leach solution 40 is directed to an ion exchange step 44 to extract a vanadium rich eluent 46 from the barren leach solution 45. The vanadium rich eluent 46 is directed to a precipitation step 48 where is it contacted with ammonia and/or ammonium sulphate, preferably in the presence of sulfuric acid to precipitate ammonium metavanadate. The resulting slurry 50 is directed to a solid liquid separation step 52. The resulting solid stream 54 is directed to a calcination step 56 to produce V₂O₅ product 58. In one embodiment, the vanadium rich eluent 46 is directed to a silica removal step (not shown) prior to the precipitation step 48. It is envisaged that the silica removal step could involve the adjustment of pH with sulphuric acid and the addition of aluminium sulphate to precipitate alumino-silicate rich particles and reduce the silicon level prior to ammonium metavanadate recovery.

In an alternative form of the present invention, the pregnant leach solution 40 is directed to a precipitation step where vanadium solids are precipitated from the pregnant leach solution 40. The precipitated solids are subsequently separated from the barren leach solution 45 and directed for further processing. It is envisaged that sodium vanadate may be directly crystallized from the pregnant leach solution 40. Alternatively, the pregnant leach solution 40 may be contacted with an ammonium species to precipitate NH₄VO₃. The resulting precipitate can be recovered and directed to a calcination step to produce a V₂O₅ product.

In an alternative form of the present invention, the pregnant leach solution 40 is directed to a solvent extraction circuit. In the solvent extraction circuit, the pregnant leach solution 40 is contacted with an organic extractant to extract vanadium ions from the aqueous phase into the loaded organic phase. The loaded organic phase may be separated from the barren leach solution 45. The loaded organic can then be contacted with a scrub solution to displace entrained aqueous phase or impurities from the loaded organic. The loaded organic will then be contacted with an aqueous strip solution to recover vanadium from the loaded organic. Vanadium may then be recovered from the aqueous strip solution by conventional means, such as for example precipitation, crystallisation or electrolysis or as described above.

In an alternative form of the present invention the pregnant leach solution 40 may be contacted with an ion exchange resin to load vanadium onto the resin. Once the loaded resin is separated from the barren leach solution 45, vanadium may be stripped from the loaded resin using an appropriate stripping agent. In one embodiment, the stripping agent is sulfuric acid. In this embodiment, the vanadyl sulphate may be crystalized directly from the strip solution.

In an alternative form of the present invention, the pregnant leach solution may be directed to a crystallisation circuit (not shown) where sodium carbonate and/or sodium bicarbonate may be selectively crystalised from the pregnant leach solution, leaving vanadium species in solution. It is envisaged that varying solubility limits of sodium carbonate/bicarbonate and vanadium species may be used to allow for the selective precipitation of these species. Where both sodium carbonate and sodium bicarbonate are precipitated, it is envisaged that these species may be crystalised simultaneously or sequentially Prior to crystallisation of either species, carbon dioxide may be injected into the leach solution to ensure the formation of carbonate/bicarbonate. It is envisaged that the solid sodium carbonate/bicarbonate could be recycled, such as by being redissolved and used in the leach stages or added into the mill with feed and water.

The barren leach solution 45 comprises a mixture of unused Na₂CO₃, NaHCO₃ and NaOH in solution. In the embodiment shown in FIG. 1, the barren leach solution 45 is directed to an evaporator 60 produce a recycle liquor 61 to reduce the water content. This recycle liquor 61 can be recycled to the pre-leach step 14 where it supplements at least a portion of the alkaline liquor 16. Alternatively, the recycle liquor 61 can be recycled to the leach step 20 (not shown) where it supplements at least a portion of the alkaline carbonate leach liquor. It is envisaged that where a carbon dioxide stream 24 is not injected into leach step 20, the recycle liquor 61 may be contacted with carbon dioxide to regenerate Na₂CO₃/NaHCO₃ from NaOH in the recycle liquor 61. It is envisaged that even if CO₂ is injected into the leach step 20 that the carbonate component of the leach liquor can be enhanced by carbonation of the returning barren solution 61.

As discussed previously, the method of the present invention is adapted to recover value from slag materials that are typically generated from the steel making industry. Steel making processes are typically carried out in a blast furnace. In a typical process, raw iron ore, coke and limestone are directed to the blast furnace where they are treated at high temperature to separate liquid iron from a liquid slag. During this process, iron oxides in the iron ore are reduced to iron and CO₂ gas evolves. Coke is ignited within the furnace and immediately reacts to generate heat and CO₂. The limestone is converted at these temperatures to CaO and CO₂ gas evolves. Each of these processes generates a substantial amount of CO₂ as a waste product and CO₂ can be the main component of the top gases released from the blast furnace. The release of the blast furnace top gases into the atmosphere is a substantial contributor to global greenhouse gas emissions.

In one embodiment of the present invention, at least a portion of the CO₂ used in the method of the present invention may be sourced from an industrial source such as a blast furnace top gases. As described above, CO₂ is used in the present invention to regenerate NaCO₃ from NaOH. CO₂ may be directly injected into the leach vessels and/or may be injected into the barren leach solution following the recovery of vanadium. It is envisaged by the inventors that the recovery of CO₂ from blast furnace top gases will reduce operating costs as fresh CO₂ does not need to be used. Furthermore, the recovery of CO₂ from the top gases will ultimately reduce the amount of CO₂ released into the atmosphere and consequently benefit the producer of the CO₂.

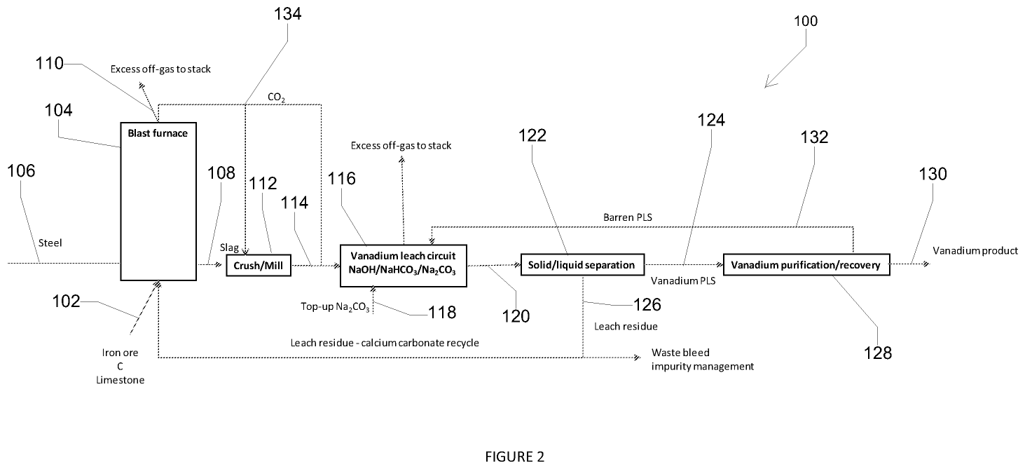

In FIG. 2, there is shown a method for the recovery of vanadium from blast furnace slags 100 in accordance with a further embodiment of the present invention. In FIG. 2, a feed stream 102 containing iron ore is directed to blast furnace 104 to produce a metallic phase 106 and slag material 108. The process also generates top gases 110 that contain significant CO₂. The slag material 108 contains vanadium and may be directed to further processing to recover vanadium. In particular, the slag material 108 is suitable for the method for the recovery of vanadium 10 described above. A simplified version of this process is shown in FIG. 2. It should be understood however, that other means for the recovery of vanadium may be implemented. The slag material 108 is directed to a primary size reduction step 112. The crushed/milled material 114 is directed to a vanadium leach circuit 116 where it is contacted with an alkaline carbonate leach solution to extract vanadium into the solution. Similarly, to the method for the recovery of vanadium 10 described above, the vanadium leach circuit 116 may comprise additional milling steps, pre-leach steps, regrinding steps and subsequent leach steps. If required, additional sodium carbonate 118 may be directed to the vanadium leach circuit 116. The resulting leach slurry 120 is directed to a solid liquid separation step 122 to produce a pregnant leach solution 124 and a leach residue 126. The leach residue 126 is washed to recover soluble vanadium and sodium salts before being discarded. The pregnant leach solution 124 is directed to a vanadium recovery circuit 128 (involving one or more of solvent extraction, ion exchange, nano-filtration or crystallization as described above) to recover a vanadium product 130 from the pregnant leach solution 124 to leave a barren leach solution 132. The barren (or vanadium depleted) leach solution 132 may then be recycled to the vanadium leach circuit 116 to at least partially supplement the leach solution. Alternatively, barren leach solution 132 may be directed to other parts of the method.

The top gases 110 from the blast furnace comprise CO₂. A CO₂ stream 134 may be recovered from the top gases 110. In one embodiment the CO₂ is recovered from the off-gas by an intermediary agent or technology and regenerated as a more concentrated or cleaner stream of gas for use in this process. In another embodiment the CO₂ containing off-gas is used directly as the CO₂ feed and introduced into the leaching or reagent recycle systems to increase the degree of carbonation of the reagents. The CO₂ stream 134 may be directed to various parts of the plant used to recover vanadium. In one embodiment, the CO₂ stream 134 is directed to the vanadium leach circuit 116. Alternatively or additionally, the CO₂ stream 134 may be injected into the barren leach solution 132 prior to being recycled to the vanadium leach circuit 116.

The leach residue 126 contains calcium carbonate and will require disposal. In the embodiment shown in FIG. 2, all or a portion of the leach residue 126 is recycled back to the blast furnace 104 to partially supplement the lime, calcium carbonate or limestone that is used in the blast furnace 104. The leach residue 126 also contains iron. By directing the leach residue 126 back to the furnace, it is envisaged that at least some of this iron may be recovered in the blast furnace 104, increasing iron yield.

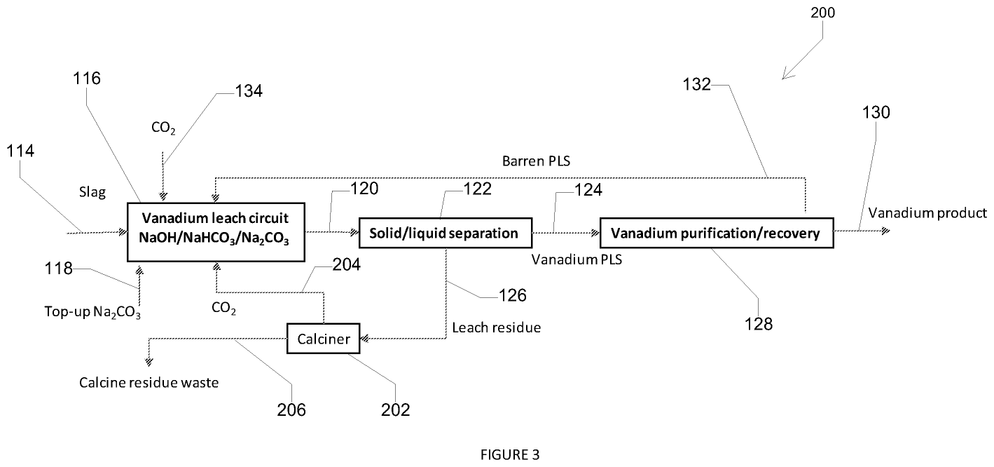

In FIG. 3, there is shown a method for the recovery of vanadium from blast furnace slags 200 in accordance with a further embodiment of the present invention. In this embodiment, leach residue 126 is directed to a calcination step 202 where it is heated to convert CaCO₃ in the leach residue 126 to CaO, while driving off CO₂. CO₂ stream 204 is captured from calcination step 202 and is directed to vanadium leach circuit 116 or to the returning barren leach solution 132 for regeneration of sodium carbonate. Solid stream 206 from the calcination step 202 is directed to tailings for disposal. Alternatively, as the solid stream 206 comprises CaO, this may be directed to a blast furnace. The solid stream 206 also comprises iron. By directing the solid stream 206 back to the blast furnace, it is envisaged that at least some of this iron may be recovered in the blast furnace 104, increasing iron yield.

As discussed above, limestone is typically used in blast furnaces and this is subsequently converted to CaO and CO₂. It is envisaged by the inventors that the calcination of limestone, either in the leach residue 124 or from other sources, can be used as both a source for CO₂ and as means to reduce CO₂ generation in the blast furnace, thereby reducing emissions.

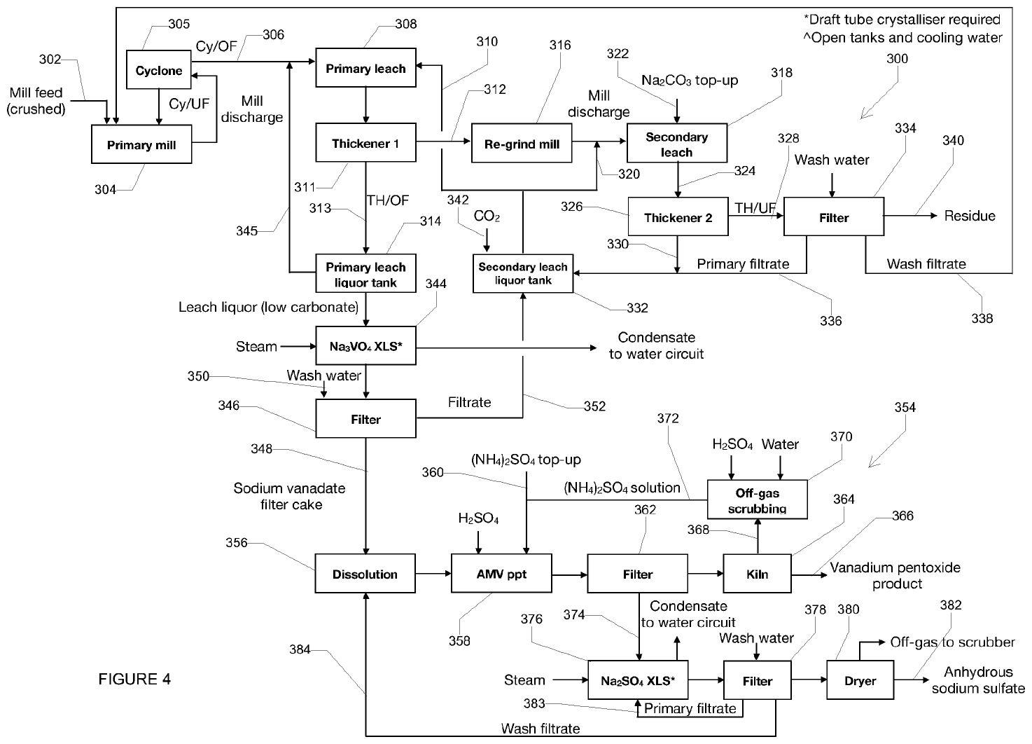

In FIG. 4, there is shown a method for the recovery of vanadium 300 from a feed stream 302 in accordance with a further embodiment of the present invention.

Feed stream 302 is directed to a primary mill step 304 where the particle size of the feed stream is reduced to the target size. The primary mill discharge is directed to a cyclone 305 to separate a primary feed stream 306. The oversized underflow is directed back to primary mill step 304 for further processing. The overflow stream 306 should have a target particle size of <200 μm, with a target particle size of <100 μm being preferred and <75 μm being more preferable. It is envisaged that other size classification apparatus may be used.

The primary feed stream 306 is directed to a primary leach step 308 where it is contacted with an alkaline carbonate leach solution 310. Where sodium is selected as the carrier, the alkaline carbonate leach solution 310 will preferably contain sodium carbonate and/or sodium bicarbonate. The alkaline carbonate leach solution 310 may further comprise sodium hydroxide. Whilst the alkaline carbonate leach solution 310 shown in FIG. 4 is a stream generated from other parts of the flowsheet, it is envisaged that fresh reagents may be used to replace or supplement this stream. During the primary leach step 308, the leach solution will extract vanadium into solution. Primary leach step 308 is operated under substantiality the same conditions as leach step 20. Depending on the precise feed material being used, the vanadium species in the feed may exist in a number of different forms. For example, calcium vanadate species may include Ca(VO₃)₂, CaV₂O₆.3H₂O, CaV₂O₆.4H₂O, CaV₆O₁₆.9H₂O, Ca₂V₂O₇.9H₂O, Ca₃V₁₀O₂₈.16H₂O, amongst others. By way of illustration, the calcium vanadates in the feedstock may react with the alkaline liquor 16 in the leaching process according to the following reactions:

Ca(VO₃)₂+M₂CO₃=CaCO₃+2MVO₃

Ca₂V₂O₇+2M₂CO₃=CaCO₃+M₄V₂O₇

(where M is an alkaline metal or alkaline earth metal)

It would be appreciated by a person skilled in the art the above reactions are included for illustration purposes only and are not an exhaustive list of the reactions occurring during the leach step.

As discussed above with respect to method 10, the presence of CaO in the feed will react with Na₂CO₃/NaHCO₃ in the leach solution to produce solid CaCO₃ and NaOH. If no further carbonates are introduced into the leach solution, the concentration of the carbonates in the leach solution will reduce as the carbonates are converted to solids. This will leave a leach solution comprising substantially of hydroxides, preventing further extraction of vanadium into solution. In method 10, a carbon dioxide stream is injected into the leach step to regenerate Na₂CO₃/NaHCO₃ in the leach solution from NaOH. Whilst this has been found to be useful in ensuring a more complete extraction of vanadium from the feed, the resulting pregnant leach solution will have a high carbonate content. The carbonate content may increase the complexity of process required to recover vanadium from the leach solution.

In the embodiment shown in FIG. 4, carbon dioxide is not introduced into the leach step to regenerate carbonates and the leach step is allowed to progress until at least a substantial amount of the carbonates in the leach solution have been depleted. Where a batch leach process is used, the residence time of the leach step is sufficient to allow the carbonate content to be reduced to a target concentration. Alternatively, where multiple leach tanks are used, the tanks may be arranged to operate in manner that ensures the carbonate content in the final stage is reduced to a target concentration. Where multiple leach stages are used, it is envisaged that carbon dioxide could be introduced in earlier leach reactors.

The option to limit the carbonate concentration in the primary leach step 308 will limit the extraction of vanadium from the primary feed. Whilst this will reduce the amount of vanadium that is recovered in the primary leach step 308, the pregnant leach solution will be a sodium hydroxide solution with a low carbonate concentration. Sodium vanadate may be crystallized directly from such solutions, thereby simplifying the recovery circuit.

The resulting slurry from the primary leach step is directed to a solid liquid separation step 311 to remove the leach residue 312 from the pregnant leach solution 313. The pregnant leach solution 313 is directed to a primary leach liquor tank 314 for further processing. A portion of the solution 345 in the primary leach liquor tank 314 may be recycled to the primary leach step 308 to increase the vanadium concentration.

The leach residue 312 may still contains a high vanadium content as a result of the limitations of the leach and may be further processed to recover further vanadium. In the embodiment shown in FIG. 4, the leach residue 312 is directed to a size reduction step 316 to reduce the particle size. In one embodiment a target maximum particles size of about 75 microns is preferred, alternatively smaller maximum particle size may be employed to achieve greater liberation and vanadium recovery. As discussed in method 10, the inventors understand that the solid CaCO₃ will form as a coating on the surface of the feedstock. The inventors have found that by subjecting the coated (partially leached) feedstock to a size reduction step 316, at least a portion of the CaCO₃ may be removed, exposing the surface of the feedstock and allowing further leaching of the vanadium. It is envisaged that any suitable milling apparatus may be used in size reduction step 316. Examples of suitable apparatus include ball mills, rod mills, autogenous grinding (AG) mills, and semi-autogenous grinding (SAG) mills.

The discharge from the size reduction step 316 is directed to a secondary leach step 318 where it is contacted with an alkaline carbonate leach solution 322 to extract vanadium into solution. Unlike the primary leach step 308, the carbonate content in the secondary leach step 318 is maintained to ensure maximum extraction. Fresh reagents, for example sodium carbonate may be directed into the secondary leach step 318 as required. The solution pH is preferably maintained to between 9 and 10 to minimise silica dissolution. Leach slurry 324 is directed to a thickening step 326 to separate a solid stream 328 from the secondary leach solution 330. Secondary leach solution 330 is directed to a secondary leach liquor tank 332 for further processing. Solid stream 328 is directed to a filtration step 334 and the primary filtrate 336 is directed to the secondary leach liquor tank 332. The filter cake is washed with water and wash filtrate 338 is recycled to the primary mill step 304 to minimize vanadium losses. Alternatively, all or portions of wash filtrate 338 may be directed to the primary or secondary mills or leach reactors to assist in vanadium and sodium recovery and the circuit water balance. Solid residue 340 is sent to tailings or may be directed for use in other applications.

The solution directed to the secondary leach liquor tank 332, may comprise a high NaOH content and so it is contacted with a carbon dioxide steam 342 to regenerate Na₂CO₃/NaHCO₃. The solution may then be directed to the primary leach step 308 as alkaline carbonate leach solution 310. A portion of the solution may also be directed to secondary leach step 318 as alkaline carbonate leach solution 320. Vanadium species in alkaline carbonate leach solution 310 will enter the primary or secondary leach solution 310 or 320 allowing subsequent recovery.

A portion of primary leach solution 345 is directed back to the primary leach step 308. Recycling the primary leach solution 345 to the primary leach reactor 308 allows for the controlled increase in the vanadium concentration without similar increase in the total sodium concentration. At an appropriate V:Na ratio the option of concentration and crystallization of one or more vanadium species (such as for example NaVO₃ or Na₃VO₄) can be exploited. A portion of the primary leach solution is directed from the primary leach liquor tank 314 to a crystallisation step 344 to crystallise sodium vanadate. As the primary leach solution is substantially free from carbonate species, the crystallisation can be carried out in a simple evaporate crystalliser.

The resulting slurry is directed to a filtration step 346 to recover a solid sodium vanadate product 348. Wash water 350 is used to remove residual sodium impurities. The filtrate and wash water 352 is a NaOH solution that contains residual vanadium and is directed to the secondary leach liquor tank 332 for carbonate regeneration. In one form of the present invention, the filtrate is directed to an ion exchange step (not shown) to recover vanadium species.

The solid sodium vanadate product 348 is directed to a vanadium recovery circuit 354. In the embodiment shown in FIG. 4, solid sodium vanadate product 348 is directed to a dissolution step 356 where it is re-dissolved in water or a dilute sulphuric acid solution. Aluminium sulphate may be added to enhance silicon removal. At this stage silica and other insoluble materials may need to the filtered from the solution. The resulting solution is directed to a precipitation step 358 where it is contacted with ammonium sulphate 360 to precipitate ammonium metavanadate. The resulting slurry is directed to a filtration step 362 and the recovered solids are directed to calcination step 364 for deammoniation and subsequent production of solid V₂O₅ 366. The off-gas 368 may be directed to a scrubbing step 370 where it is contacted with sulphuric acid to recover ammonium sulphate 372. The recovered ammonium sulphate 372 may then be directed back to the precipitation step 358.

Barren liquor 374 from filtration step 362 is directed to a crystallisation step 376 to recover sodium sulphate crystals. The resulting slurry is directed to a filtration step 378 and the recovered solid is directed to a drying step 380 to recover a final sodium sulfate product 382. Primary filtrate 383 is recycled back to crystallisation step 376 and wash filtrate 384 is directed to dissolution step 356. In one form of the present invention, barren liquor 374 or primary filtrate 383 are directed to an ion exchange step (not shown) to recover residual vanadium species.

In FIG. 5, there is shown a method for the recovery of vanadium 400 from a feed stream 402 in accordance with a further embodiment of the present invention.

Feed stream 402 is directed to a primary mill step 404 where the particles size of the feed stream is reduced to the target size. The primary mill discharge 406 is directed to a leach step 408 where it is contacted with an alkaline carbonate leach solution 410. In the embodiment shown in FIG. 5, either sodium or potassium may be used as the carrier and the alkaline carbonate leach solution 410 will preferably comprise sodium or potassium carbonate/bicarbonate. In this embodiment, fresh sodium/potassium carbonate solution is fed directly into the leach step 408. During the primary leach step 408, the leach solution will extract vanadium into solution. Primary leach step 408 is operated under substantiality the same conditions as leach step 20. Depending on the precise feed material being used, the vanadium species in the feed may exist in a number of different forms. For example, calcium vanadate species may include Ca(VO₃)₂, CaV₂O₆.3H₂O, CaV₂O₆.4H₂O, CaV₆O₁₆.9H₂O, Ca₂V₂O₇.9H₂O, Ca₃V₁₀O₂.16H₂O, amongst others. By way of illustration, the calcium vanadates in the feedstock may react with the alkaline liquor 16 in the leaching process according to the following reactions:

Ca(VO₃)₂+M₂CO₃=CaCO₃+2MVO₃

Ca₂V₂O₇+2M₂CO₃=CaCO₃+M₄V₂O₇

(where M is an alkaline metal or alkaline earth metal)

It would be appreciated by a person skilled in the art the above reactions are included for illustration purposes only and are not an exhaustive list of the reactions occurring during the leach step.

In the embodiment shown in FIG. 5, carbon dioxide is not introduced into the leach step to regenerate carbonates and the leach step is allowed to progress until at leach a substantial amount of the carbonates in the leach solution have been depleted. Where a batch leach process is used, the resonance time of the leach step is sufficient to allow the carbonate content to be reduced to a target concentration. Alternatively, where multiple leach tanks are used, the tanks may be arranged to operate in manner that ensures the carbonate content in the final stage is reduced to a target concentration.

The resulting slurry from the primary leach step is directed to a solid liquid separation step (not shown) to remove the leach residue 412 from the pregnant leach solution 414.

The primary leach solution 414 is directed to a vanadium recovery circuit 416. In the embodiment shown in FIG. 5, the primary leach solution 418 is directed to a crystallisation step 420 to crystallise sodium/potassium vanadate. As the primary leach solution 414 is substantially free from carbonate species, the crystallisation can be carried out in a simple evaporate crystalliser.

The resulting slurry is directed to a filtration step (not shown) to recover a solid sodium/potassium vanadate product 422. The barren pregnant leach solution 424 contains sodium/potassium hydroxide and is directed to a crystallisation step 426 where is it contacted with sulphuric acid to crystallise sodium/potassium sulfate 428.

The solid sodium/potassium vanadate product 422 is dissolved in a sulphuric acid solution 428 and the resulting solution is directed to a precipitation step 430 where it is contacted with ammonia/ammonium sulphate 432 to precipitate ammonium metavanadate. The recovered solids (AMV) are directed to calcination step 434 for deammoniation and subsequent recovery of V₂O₅ 436. The off-gas 438 may be treated to recover ammonium sulphate 440. The recovered ammonium sulphate 440 may then be directed back to the precipitation step 430.

In the embodiment shown in FIG. 5, the flow sheet is simplified by electing not to regenerate carbonates from the barren pregnant leach solution. Instead, fresh reagent 410 is added directly to the primary leach step 408. Whilst the use of fresh reagent in the primary leach step 408 will increase the input reagent costs, the inventors have found that this may be offset by the value of the byproduct sodium/potassium sulfate solids. Whilst sodium or potassium may also be used in this embodiment, the sodium sulfate byproduct is likely to be less valuable than the potassium sulfate byproduct.

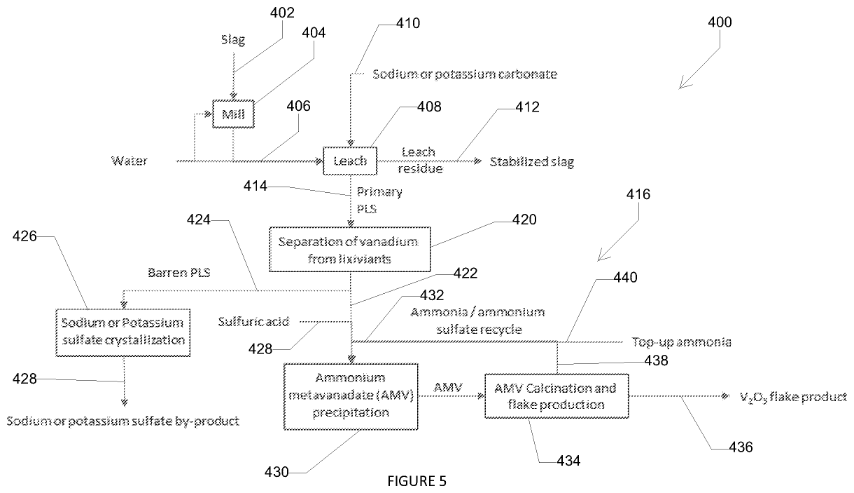

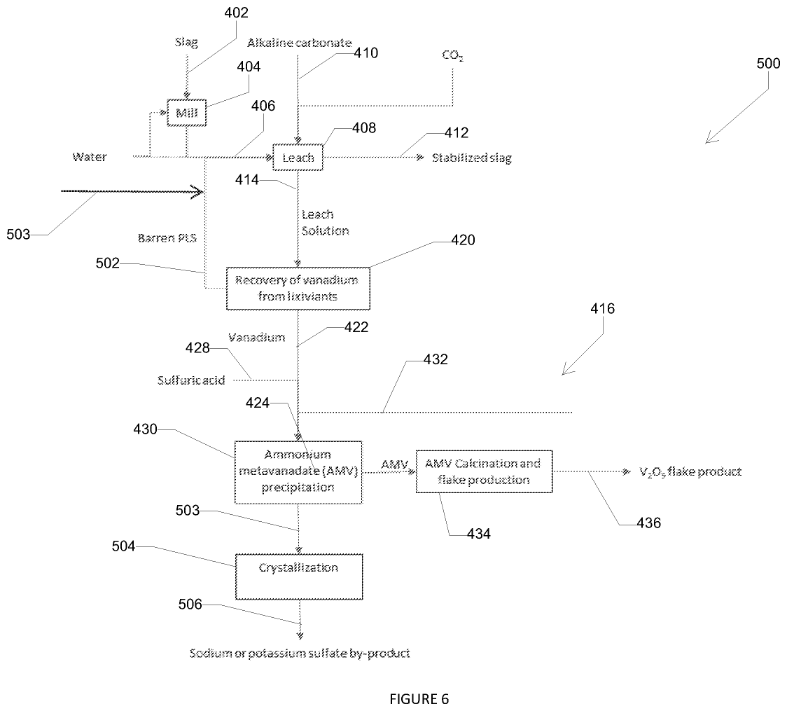

In FIG. 6, there is shown a method for the recovery of vanadium 500 from a feed stream 402 in accordance with a further embodiment of the present invention. Method 500 share many similarities with method 400 and like numerals denote like parts.

Feed stream 402 is directed to a primary mill step 404 where the particles size of the feed stream is reduced to the target size. The primary mill discharge 406 is directed to a leach step 408 where it is contacted with an alkaline carbonate leach solution 410. The alkaline carbonate leach solution 410 will preferably comprise sodium carbonate/bicarbonate or potassium carbonate/bicarbonate. In this embodiment, alkaline carbonate solution is fed directly into the leach step 408. During the primary leach step 408, the leach solution will extract vanadium into solution. Primary leach step 408 is operated under substantiality the same conditions as leach step 20.

In the embodiment shown in FIG. 6, carbon dioxide is not introduced into the leach step to regenerate carbonates and the leach step is allowed to progress until at leach a substantial amount of the carbonates in the leach solution have been depleted. Where a batch leach process is used, the resonance time of the leach step is sufficient to allow the carbonate content to be reduced to a target concentration. Alternatively, where multiple leach tanks are used, the tanks may be arranged to operate in manner that ensures the carbonate content in the final stage is reduced to a target concentration.

The resulting slurry from the primary leach step is directed to a solid liquid separation step (not shown) to remove the leach residue 412 from the pregnant leach solution 414.

The primary leach solution 414 is directed to a vanadium recovery circuit 416. In the embodiment shown in FIG. 6, the primary leach solution 418 is directed to a crystallisation step 420 to crystallise vanadate solids. As the primary leach solution 414 is substantially free from carbonate species, the crystallisation can be carried out in a simple evaporate crystalliser.

The resulting slurry is directed to a filtration step (not shown) to recover a solid vanadate product 422. The barren pregnant leach solution 502 contains sodium/potassium hydroxide and is recycled to the leach step 408. The barren pregnant leach solution 502 may be contacted with carbon dioxide 503 to regenerate carbonates from the hydroxide solution.

The solid sodium/potassium vanadate product 422 is dissolved in sulphuric acid 428 and the resulting solution is directed to a precipitation step 430 where it is contacted with ammonia/ammonium sulphate 432 to precipitate ammonium metavanadate. The recovered solids are directed to calcination step 434 for deammoniation and subsequent crystallisation of solid V₂O₅ flakes 436. The off-gas may be treated to recover ammonium sulphate as per FIG. 5, 400. The recovered ammonium sulphate may then be directed back to the precipitation step 430. The filtrate 503 from the precipitation step 430 is directed to a crystallisation step 504 to recover sodium or potassium sulfate 506.

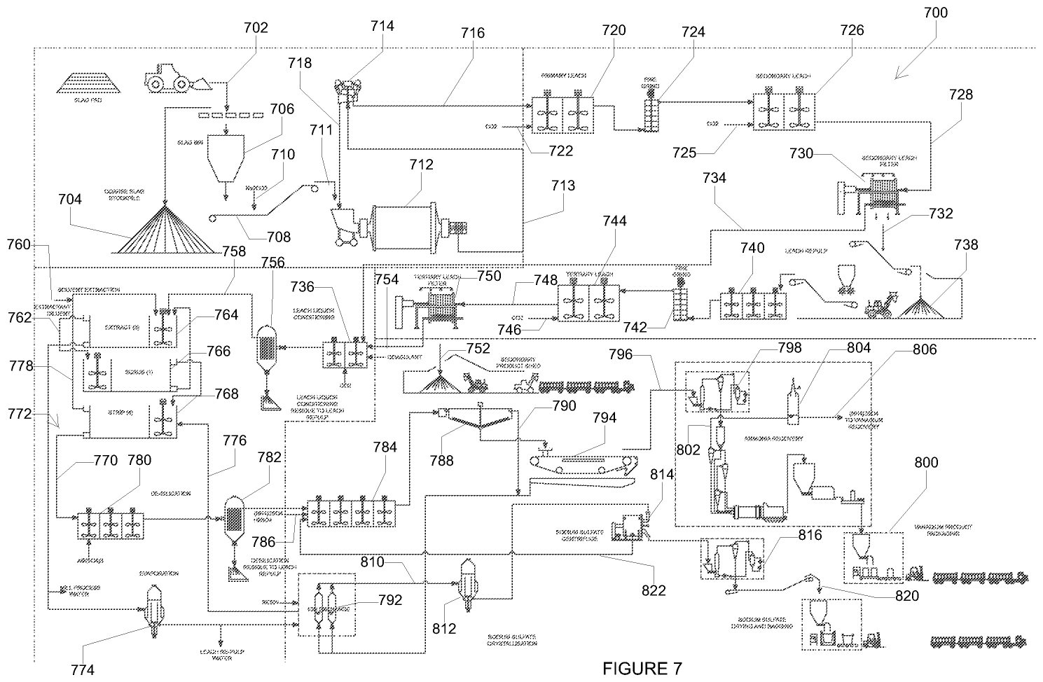

In FIG. 7, there is shown a method for the recovery of vanadium 700 from a feed stream 702 in accordance with a further embodiment of the present invention.

Feed stream 702 is directed to a screen and oversize material is diverted to a coarse material stockpile 704. Undersize material is directed to a storage hopper 706. The material in the storage hopper 706 is fed onto a feed conveyor 708 at a controlled rate. Top up solid sodium carbonate 710 is added to the material on the conveyor at the required rate. The combined stream 711 is directed to a primary mill step 712 where the particle size of the feed stream is reduced to the target size. Process water is added to the mill with the material feed in the primary mill step 712. Process water will dissolve the solid sodium carbonate 710 to form an alkaline carbonate solution which will begin leaching vanadium values from the combined stream 711. Process water may also comprise dissolved alkaline carbonate materials and recycled aqueous streams may be recycled from other parts of the process, for example the SX raffinate. The primary mill discharge 713 is directed to a cyclone 714 to separate a primary feed stream 716 (cyclone overflow). The oversized underflow 718 is directed back to primary mill step 712 for further processing. The overflow stream 716 should have a target particle size of <200 μm, with a target particle size of <100 μm being preferred and <75 μm being more preferable.

The primary feed stream 716 is directed to a primary leach step 720 where the dissolved sodium carbonate and/or sodium bicarbonate in the solution will further extract vanadium values into solution. The leach solution is preferably heated to the target temperature range and the solution pH is maintained. The preferred temperature range is 70° C.-90° C. Primary leach step 720 is operated under substantiality the same conditions as leach step 20.

As discussed above with respect to method 10, the presence of CaO or Ca(OH)₂ in the feed material will react with Na₂CO₃/NaHCO₃ in the leach solution to produce solid CaCO₃ and NaOH. If no further carbonates are introduced into the leach solution, the concentration of the carbonates in the leach solution will reduce as the carbonates are converted to solids. This will leave a leach solution comprising substantially of hydroxides, limiting further extraction of vanadium into solution and raising the solution pH, thus encouraging some impurities to dissolve further. A carbon dioxide stream 722 is injected into the leach step to regenerate Na₂CO₃/NaHCO₃ in the leach solution from NaOH and maintain the pH within a target range of 8.0-11.0 with a range of 9.5-10 being preferred.

The leach residue may still contain a high vanadium content as a result of the limitations of the leach (including particle size, vanadium liberation and calcium carbonate precipitation) and may be further processed to recover further vanadium. In the embodiment shown in FIG. 7, the leach discharge slurry is directed to a size reduction step 724 to reduce the particle size of the solids. In one embodiment a target maximum particles size of about 75 microns is preferred, alternatively smaller maximum particle size may be employed to achieve greater liberation and vanadium recovery. As discussed in method 10, the inventors understand that the solid CaCO₃ will form as a coating on the surface of the feedstock. The inventors have found that by subjecting the coated (partially leached) feedstock to a size reduction step 724, at least a portion of the CaCO₃ may be removed and particle sizes are reduced, exposing the surface of unreacted feedstock and allowing further leaching of the vanadium. It is envisaged that any suitable milling apparatus may be used in size reduction step 724. Examples of suitable apparatus include ball mills, rod mills (including vertical roller mills), autogenous grinding (AG) mills, and semi-autogenous grinding (SAG) mills. Additional leaching can occur in the regrind mill 724 if carbonates/bicarbonates are present in the liquor within the mill.

The discharge from the size reduction step 724 is directed to a secondary leach step 726 where the dissolved sodium carbonate and/or sodium bicarbonate in the solution will further extract vanadium values into solution. The leach solution is preferably heated to the target temperature range and the solution pH is maintained. Secondary leach step 726 is operated under substantiality the same conditions as leach step 720. A carbon dioxide stream 725 is injected into the secondary leach step 726 to regenerate Na₂CO₃/NaHCO₃ in the leach solution from NaOH and maintain the desired pH.

Leach slurry 728 is directed to a solid liquid separation step 730 to separate a solid stream 732 from the secondary leach solution 734. Secondary leach solution 734 is directed to the leach liquor conditioning stage 736. The recovered solids 732 are washed on the filter with water or a brine from the evaporator and the solvent extraction raffinate, described in more detail below. The resulting slurry is directed to a size reduction step 742 to reduce the particle size of the solids in a manner analogous to step 724. Alternatively, leach slurry 728 may be directed to one or more size reduction steps, where each size reduction step is followed by a leach step.

The discharge from the size reduction step 742 is directed to a tertiary leach step 744 to further extract vanadium. A carbon dioxide stream 746 is injected into the leach step to regenerate Na₂CO₃/NaHCO₃ in the leach solution from NaOH. The solution temperature and pH are maintained at target values during the tertiary leach step 744 in a manner similar to that used in the primary and secondary leach stages. As discussed above, further combinations of size reduction steps and leach steps may follow the tertiary leach step 744 as required.

Tertiary leach slurry 748 is directed to a solid liquid separation step 750 to separate a solid stream 752 from the tertiary leach solution 754. Tertiary leach solution 754 is directed to the leach liquor conditioning step 736. The filtered solids are washed one or more times on the filter preferably in a counter-current manner to recover any entrained solution and any soluble vanadium or sodium from the filter cake. The washed recovered solids are collected and may be directed to storage or other applications.

Combined leach solution from the secondary leach step 726 and the tertiary leach step 744 are directed to the conditioning step 736. In the conditioning step 736, the pH and temperature are adjusted and coagulant is added to help remove colloidal silica. The resulting solution is directed to a solid liquid separation step 756 to remove any solids from the treated leach solution 758.

The treated leach solution 758 is directed to the extraction section of a vanadium solvent extraction circuit where it is contacted with an organic solution comprising a vanadium extractant 760. Vanadium is loaded onto the vanadium extractant and the loaded organic solution 762 is separated from the aqueous leach solution. Vanadium product is subsequently recovered from the loaded organic solution 762.

In the embodiment shown in FIG. 7, the vanadium extraction circuit comprises an extraction stage 764, a scrubbing stage 766 and a stripping stage 768 to selectively recover vanadium from the treated leach solution 758 into a vanadium strip liquor 770.

The vanadium-free (or vanadium depleted) SX raffinate 772 is filtered to remove entrained solids and organic and is directed to a holding tank for further processing. The primary use of the SX raffinate 772 is in the primary milling circuit. Excess SX raffinate 772 is directed to an evaporator 774 to increase sodium concentration. The concentrated solution may then be recycled to one of the leach stages or size reduction steps.

In one embodiment of the present invention, the extraction stage 764 comprises one or more solvent extraction contactors such as mixer settlers or column contactors. More preferably, the extraction stage 764 comprises two or more solvent extraction mixer settlers. Still preferably, the extraction stage 764 comprises three or more solvent extraction mixer settlers.

In one embodiment, where the extraction stage 764 comprises two or more solvent extraction mixer settlers, the two or more solvent extraction mixer settlers are arranged in series.

In one embodiment, where the extraction stage 764 comprises two or more solvent extraction mixer settlers arranged in series, the mixer settlers are arranged for counter-current operation.

The treated leach solution 758 is directed to the first mixer settler where it is contacted with an organic solution comprising a vanadium extractant 760 to selectively extract vanadium from the treated leach solution 758. The treated leach solution 758 and the organic solution comprising a vanadium extractant 760 are contacted in a counter-current arrangement to maximize extraction efficiency.

In a preferred form of the present invention, the vanadium extractant is a quaternary ammonium extractant. Preferably, the vanadium extractant is Aliquat 336.

In one form of the present invention, the organic solution comprises a modifier. In one form of the present invention, the organic solution comprises between 0% and 50% modifier. In one embodiment, the organic solution comprises between 25% and 35% modifier. In one embodiment, the organic solution comprises between 5% and 10% modifier. As would be appreciated by a person skilled in the art, modifiers can be used to improve the chemical or physical performance of the solvent extraction system. In one form of the present invention, the modifier is selected from tridecanol, isodecanol or isotridecanol.

In one form of the present invention, the organic solution is not diluted. In one form of the present invention, the organic extractant is diluted to a target concentration with a diluent. Preferably, the target concentration is between 20% and 40% on a volume basis. More preferably, the target concentration is about 25% on a volume basis. In one embodiment, the target concentration is between 5% and 10%. As would be appreciated by a person skilled in the art the dilution of the organic solution is used to control viscosity and improve phase separation. In one form of the invention, where the organic solution is diluted with a diluent, the diluent is kerosene or Shellsol 2046.

In one form of the present invention, the ratio of organic to aqueous in the extraction stage is between 12:1 and 1:12. Preferably, the ratio of organic to aqueous in the extraction stage is between 4:1 and 1:4. More preferably, the ratio of organic to aqueous in the extraction stage is between 1:1 and 1:2. As would be appreciated by a person skilled in the art, the ratio of organic to aqueous in the extraction stage is dependent on the vanadium tenor in the pregnant leach solution as well as the loading of vanadium on the organic. One method for calculation of equilibrium concentration of extractant is using the material balance, i.e. it is equal to the difference between total (analytical) concentration of extractant and the sum of all solvated species in the solvent phase. As will be familiar to someone with experience in solvent extraction, manipulation of the O:A ratio in both the vanadium extraction and stripping stages can be used to simultaneously increase the concentration of vanadium in the final strip solution whilst improving the purity of the product vanadium solution.

In one form of the present invention, the target pH of the pregnant leach solution in the extraction stage is between 8 and 11. In one form of the present invention the target pH of the pregnant leach solution in the extraction stage is between 9 and 10. In an alternative form of the present invention, the pH is not controlled.

The loaded organic solution 762 is directed to a scrubbing stage 766. In scrubbing stage 766, the vanadium loaded organic solution 762 is contacted with a portion of a scrub solution. The scrub solution displaces any weakly loaded or entrained impurity elements loaded onto the loaded organic solution 762 in the extraction stage 764. In a preferred embodiment, the scrub solution is prepared from a diluted strip liquor. O:A ratio is managed in the scrubbing section to ensure a reasonable O:A ratio in the contactor whilst only having a relatively small quantity of loaded scrub solution progressing forward to the extraction stage 764. In one embodiment of the present invention, the ratio of the vanadium loaded organic solution to the aqueous scrub solution is between 1:1 and 1:2 (organic:aqueous) on a volume basis.

In one embodiment of the present invention, the scrubbing stage 766 comprises one or more mixer settlers.

The aqueous phase from the scrubbing stage 766 is directed back to the first extraction mixer-settler 764. Loaded organic solution from the scrubbing stage 766 advances to a stripping stage 768. In the stripping stage 768, the loaded organic solution is contacted with a strip solution 776 to displace the majority of vanadium ions on the organic into the aqueous phase, producing the vanadium strip liquor 770.

In one embodiment of the present invention, the strip solution is selected from the group comprising: sodium carbonate, ammonium carbonate, ammonium chloride, ammonium carbonate, ammonia, sulfuric acid, sodium hydroxide and potassium hydroxide. In a preferred embodiment, the strip solution is a sodium hydroxide solution. Preferably, at least a portion of the sodium hydroxide is recycled from other parts of the process.

In one embodiment, the stripping stage 768 comprises one or more mixer settlers. Preferably, the stripping stage 768 comprises two or more mixer settlers. More preferably, the stripping stage 768 comprises three or more mixer settlers. In an embodiment where the stripping stage 768 comprises two or more mixer settlers, the two or more mixer settlers are arranged in series.

In one form of the present invention, the ratio of the vanadium loaded organic solution to the aqueous strip solution is between 2:1 and 10:1 (organic:aqueous) on a volume basis. Preferably the ratio is between 5:1 and 7:1 (organic:aqueous) on a volume basis.

The organic phase 778 exiting the stripping stage 768 is recycled to the extraction stage 764 where it again loads with vanadium. In this way, the organic phase 778 is kept in a closed circuit within the vanadium solvent extraction circuit. The vanadium strip liquor 770 from the stripping stage 768 is directed to vanadium recovery.

In the embodiment shown in FIG. 7, the vanadium strip liquor 770 is directed to a desilication step 780 where it is contacted with an aluminium salt, for example aluminium sulphate to precipitate aluminium silica compounds. Silica removal may require pH adjustment and this is most readily achieved with a small quantity of sulphuric acid.

The precipitated solids and other insoluble materials are removed in a solid liquid separation step 782.

The filtrate is directed to a precipitation step 784 where it is contacted with ammonium sulphate 786 to precipitate ammonium metavanadate. Sulphuric acid may be added to precipitation step to control solution pH for optimal vanadium recovery. A target pH of between 8-9 is preferred. The resulting slurry is directed to a thickening step 788 and the clarified overflow solution (AMV barren liquor) 790 is directed to an ion exchange step 792. The thickener underflow is directed to a filtration step 794 and the filtrate is similarly directed to the ion exchange step 792. The filtered solids are washed with dilute ammonium sulphate solution to remove any entrained liquors and further purify the filter cake. The recovered solids 796 are directed to calcination step 798 for deammoniation and subsequent powder melting and production of solid V₂O₅ flakes 800. The off-gas 802 may be directed to a scrubbing step 804 where it is contacted with sulphuric acid to recover ammonia and form ammonium sulphate 806. The recovered ammonium sulphate 806 may then be directed back to the precipitation step 784.

The thickener overflow 790 and the filtrate from filtration step 794 are combined with a bleed solution from the evaporator 774. In this flowsheet the combined low vanadium liquors are directed toward an optional ion exchange circuit for vanadium recovery. An alternative similar flowsheet might not include this stage and still recover remaining vanadium after the sodium sulphate circuit. In the embodiment shown in FIG. 7, the solution is directed to the ion exchange step 792 to recover vanadium from the solution onto an ion exchange medium. Vanadium is subsequently stripped from the ion exchange medium using sodium hydroxide and the strip solution 776 is directed to the stripping stage 768. The IX raffinate solution 810 is directed to a crystallisation step 812 to recover sodium sulphate crystals. The resulting slurry is directed to a solid liquid separation step 814 such as a centrifuge and the recovered solids are directed to a drying step 816 to recover a final sodium sulfate product 820. Primary filtrate (or centrate) 822 is recycled back to precipitation step 784.

### Example 1

A 400 g sample of steel slag (Lulea composite) was added to 400 gpl sodium carbonate solution (made up in Perth scheme water) at a pulp density of 15% solids by weight and agitated in a glass reactor. Hydrogen peroxide was added periodically to maintain an Eh close to zero. The test was maintained at 90° C. for twelve hours. The test was terminated after twelve hours and the pulp filtered, assayed and stored. The raw data is presented in Table 1.

TABLE 1
Leach Analysis

| | Mass | Vanadium | | Titanium | | Iron | |
|---|---|---|---|---|---|---|---|
| | (g) | (ppm) | % dist | (ppm) | % dist | (ppm) | % dist |
| Residue | 601 | 2490 | 15.2 | 4420 | 100 | 109940 | 100 |
| Filtrate | 1293 | 6678 | 84.8 | 1 | 0 | 9 | 0 |
| Feed | 398 | 24600 | 100 | 7200 | 100 | 178800 | 100 |

The leach demonstrated high selectivity of vanadium over other titanium and iron.

### Example 2

A slag containing 2.4% V was wet milled to a P80 75 micron. The milled product was then subjected to an alkaline carbonate leach using a solution containing 50 g/L sodium carbonate at 15% solids. The test was conducted under ambient conditions, 25-30° C. and atmospheric pressure. The pH was reduced and maintained at pH 10.0 by sparging carbon dioxide. The vanadium extraction reached 47% after 5 hours of leaching.

The leach slurry was filtered and washed and the residue was ground finer (P80<75 micron). The ground residue was then subjected to an alkaline carbonate leach using a solution containing 50 g/L sodium carbonate at 15% solids. The test was conducted under ambient conditions, 25-30° C. and atmospheric pressure. The pH was reduced and maintained at pH 10.0 by sparging carbon dioxide. The overall (after both leach stages) vanadium extraction reached 75% after a further 5 hours of leaching.

### Example 3

An alkaline carbonate leach solution containing 3.1 g/L V was contacted with an organic solution containing 10% Aliquat 336 and 5% isodecanol in Shellsol 2046 at an O/A ratio of 1:5. The resultant raffinate contained 140 ppm V and loaded organic contained 14.8 g/L V. This results in an extraction of 95% in a single stage.

### Example 4

A slag sample containing 1.9% V and 15.5% Fe was wet milled to a P80 75 micron. The milled product was then subjected to an alkaline carbonate leach using a solution containing 200 g/L sodium carbonate at 25% solids. The test was conducted with a carbon dioxide sparge, at 25° C. The pH was reduced and maintained at pH 9.0-9.5 during the leaching reaction. The vanadium extraction reached 48% after 8 hours of leaching with <1% iron leaching.

### Example 5

A slag sample containing 1.9% V and 15.5% Fe was wet milled to a P80 75 micron. The milled product was then subjected to an alkaline carbonate leach using a solution containing 200 g/L sodium carbonate at 25% solids. The test was conducted with a carbon dioxide sparge, at 65° C. The pH was reduced and maintained at pH 9.0-9.5 during the leaching reaction. The vanadium extraction reached 55% after 8 hours of leaching with <1% iron leaching.

### Example 6

A slag sample containing 1.9% V and 15.5% Fe was wet milled to a P80 75 micron. The milled product was then subjected to an alkaline carbonate leach using a solution containing 200 g/L sodium carbonate at 25% solids. The test was conducted with a carbon dioxide sparge, at 90° C. The pH was reduced and maintained at pH 9.0-9.5 during the leaching reaction. The vanadium extraction reached 63% after 8 hours of leaching with <1% iron leaching.

### Example 7

A slag sample containing 1.9% V and 15.5% Fe was wet milled to a P80 38 micron. The milled product was then subjected to an alkaline carbonate leach using a solution containing 200 g/L sodium carbonate at 25% solids. The test was conducted with a carbon dioxide sparge, at 90° C. The pH reduced and was maintained at pH 9.0-9.5 during the leaching reaction. The vanadium extraction reached 63% after 8 hours of leaching with <1% iron leaching.

### Example 8

A slag sample containing 1.9% V and 15.5% Fe was wet milled to a P80 75 micron. The milled product was then subjected to an alkaline carbonate leach using a solution containing 200 g/L sodium carbonate at 15% solids. The test was conducted under an overpressure of 770 kPa with a 50:50 CO₂:O₂ gas mix, at 150° C. The pH reduced and was maintained at pH 9.5-10.0 during the leaching reaction. The vanadium extraction reached 68% after 6 hours of leaching.

The leach slurry was filtered and washed and the residue was ground finer (P80<38 micron). The ground residue was then subjected to an alkaline carbonate leach using a solution containing 200 g/L sodium carbonate at 7% solids. The test was conducted at 90° C. and atmospheric pressure. The pH was reduced and maintained at pH 10.0 by sparging carbon dioxide. The overall (after both leach stages) vanadium extraction reached 84% after a further 6 hours of leaching with <1% iron leaching.

### Example 9

A slag sample containing 1.9% V and 15.5% Fe was wet milled to a P80 38 micron. The milled product was then subjected to an alkaline carbonate leach using a solution containing 200 g/L sodium carbonate at 15% solids. The test was conducted under an overpressure of 770 kPa with a 50:50 CO₂:O₂ gas mix, at 150° C. The pH was reduced and maintained at pH 9.0-9.5 during the leaching reaction. The vanadium extraction reached 75% after 6 hours of leaching with <1% iron leaching.

### Example 10

Sample steel slags were obtained from a steel production facility. These samples were crushed to a particle size of −3.35 mm and were combined to provide a master composite sample. The master sample was submitted for head assay. The composited was found to contain 2.41% V, 28.7% Ca, 4.06% Si, 0.91% Al and 17.0% Fe. A sample of the composite was assayed via quantitative XRD. The results are presented in Table 2.

TABLE 2
Mineral composition of the Master Composite

| | | Mineral composition |
|---|---|---|
| Mineral | Mineral formula | in the Master comp (%) |
| Portlandite | Ca(OH)₂ | 29.5 |
| Brownmillerite | Ca₂Al_{1.1}Fe_{0.9}O₅ | 19.0 |
| Wuestite | FeO | 12.8 |
| Calcite | CaCO₃ | 7.42 |
| Perovskite | CaTiO₃ | 6.61 |
| Ankerite | CaFe_{0.6}Mg_{0.3}Mn_{0.1}(CO₃)₂ | 2.77 |
| Lime | CaO | 2.37 |
| Coulsonite | FeV₂O₄ | 5.51 |
| Bixbyite | Mn_{1.5}Fe_{1.5}O₃ | 4.66 |
| Quartz | SiO₂ | 9.36 |

A series of sighter leach tests were conducted to assess the effect of various leach parameters on the extraction of vanadium from the feedstock.

An initial base-line leach test was conducted to enable a point of comparison. This test involved leaching the master composite same at P80 75 μm, 50° C. and 20% solids with carbon dioxide sparging to target pH 9.0. The pH of the slurry reduced from pH>12.0 to pH 9.0 within 5 minutes of carbon dioxide sparging, indicating relatively fast reaction of free hydroxide ions with carbon dioxide. The vanadium extraction efficiency reached 38% within the first hour with minimal change thereafter.

### Effect of Particle Size

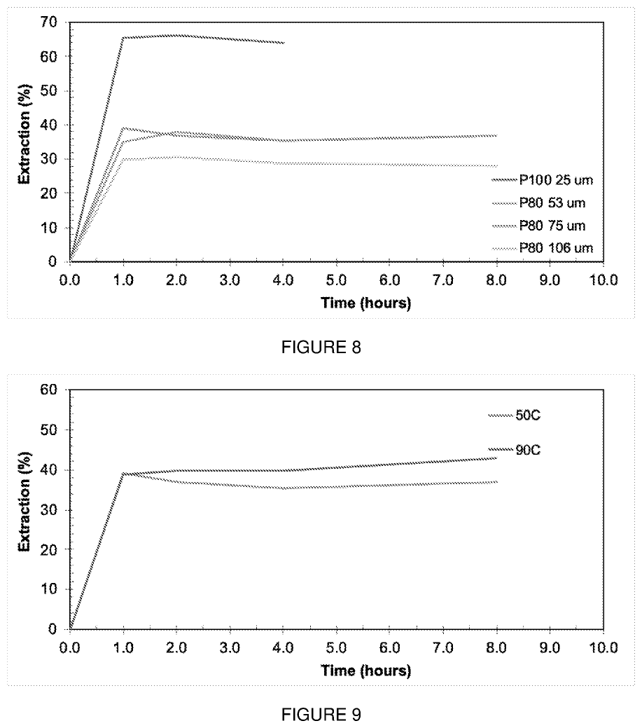

The effect of grind size was determined by leaching the master composite sample, ground to P80 106 μm, 75 μm, 53 μm and P100 25 μm with all other conditions being equal to the base-line. The results are presented in FIG. 8. A significant reduction in vanadium extraction (approximately 10%) was evident when leaching at a grind size of P80 106 μm. There was no significant difference in vanadium extraction when leaching at P80 75 μm and P80 53 μm. However, the vanadium extraction increased significantly (+25%) when the feed was ground to P100 25 μm. These results suggest grind size is critical for high vanadium extraction.

### Effect of Temperature

The effect of temperature was determined by leaching Master composite, ground to P80 75 μm, at 90° C. with all other conditions being equal to the base-line. The results are presented in FIG. 9. The vanadium extraction is marginally higher at 90° C. in comparison to 50° C.

### Effect of Sodium Carbonate Concentration

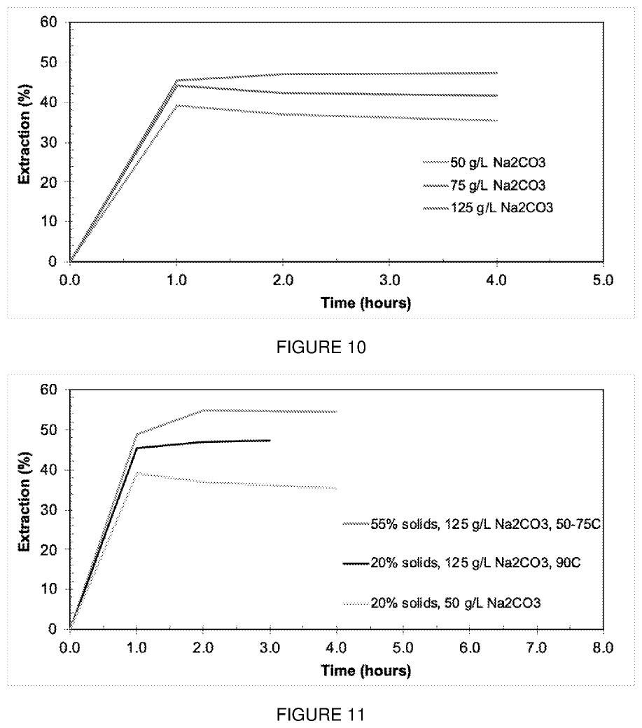

The effect of sodium carbonate concentration was determined by leaching Master composite, ground to P80 75 μm, in 75 g/L Na₂CO₃ and 125 g/L Na₂CO₃ with all other conditions being equal to the base-line. The results are presented in FIG. 10. The vanadium extraction increased with increasing sodium carbonate concentration and reached 47% with 125 g/L Na₂CO₃ under baseline conditions. However, it is also noted that the sodium grade of the leached solids increased marginally with sodium carbonate concentration. For the 50, 75 and 125 g/L Na₂CO₃ leach tests the leached solids contained 0.73% Na, 0.77% Na and 0.78% Na, respectively.

### Effect of Percent Solids

The effect of percent solids was determined by leaching Master composite, ground to P80 75 μm, at 55% solids with 125 g/L Na₂CO₃ at 50-75° C. The test was not conducted with 50 g/L Na₂CO₃ as there would be an insufficient stoichiometric mass of sodium carbonate in the reactor. The results are presented and compared with the base-line as well as with 125 g/L Na₂CO₃ at 20% solids in FIG. 11. The extraction of vanadium was significantly improved in comparison to the base-line. It was noted that the temperature of the slurry increased to 75° C. in this test due to the exothermic reaction between carbon dioxide and sodium hydroxide. The temperate increase was more evident for this test in comparison to the base line due to the higher concentration of sodium and vanadium in the liquor. The leach liquor after 1 hour contained 48 g/L Na and 18 g/L V.

### Effect of Oxidation Redox Potential

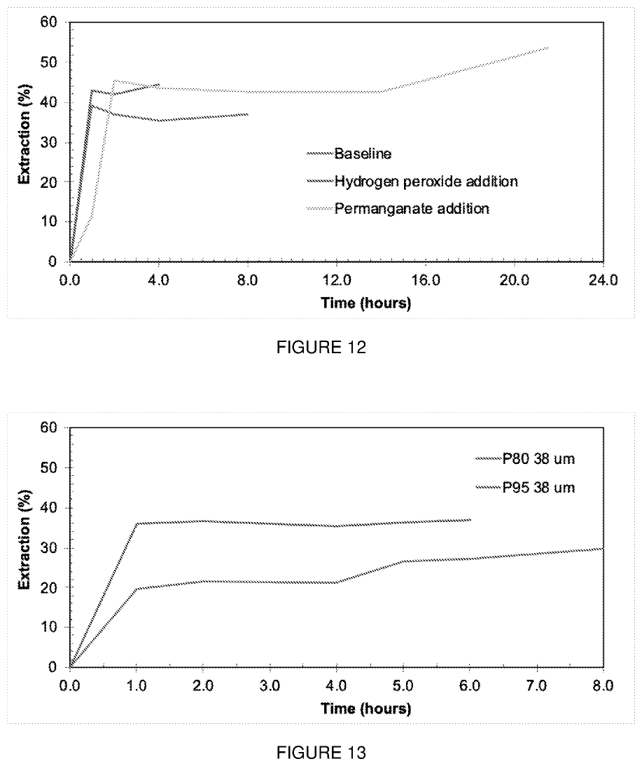

The effect of oxidation redox potential (ORP) was determined by leaching Master composite under baseline conditions with hydrogen peroxide addition to target >200 mV. The hydrogen peroxide addition (30% (v/v) was 160 kg/t of slag. A second test was conducted under baseline conditions with potassium permanganate addition (20 kg/t) to >400 mV. For this test, the temperature was increased to 90° C. after 14 hours. The results are presented and compared with the baseline in FIG. 12.

The addition of an oxidant showed an improvement in the vanadium extraction. With hydrogen peroxide addition, the vanadium extraction was 8.7% higher than the baseline after 4 hours. With potassium permanganate addition, the vanadium extraction was 15.5% higher after heating to 90° C. Although the addition of oxidant results in a higher vanadium extraction in comparison to the baseline, it does not provide a higher extraction in comparison to a finer grind size. This suggests the ORP is not the sole driver for vanadium extraction.

### Example 11

The vanadium extraction is understood to be dependent upon the extent of reaction of the calcium present in the slag to form calcium carbonate. It is understood by the inventors that calcium carbonate forms on the surface of the slag particles during the leach step, thereby occluding calcium in the slag from further leaching. A series of leach tests were conducted to assess the effect of grinding and re-leaching the leached slag in an attempt to enable more calcium to react with carbonate.

A bulk leach was conducted to prepare primary leached solids for subsequent re-grind and leach test work. This test involved leaching milled slag (P80 75 μm) at 48% solids using 125 g/L Na₂CO₃ with carbon dioxide sparging to target pH 9.2-10. Kinetic samples were taken after 1, 2, 4 and 6 hours of leaching. The vanadium extraction kinetics were rapid, achieving 51% V extraction within 1 hour, with no significant change thereafter. The pH of the test was 10.0 for the first 4 hours and was subsequently reduced to 9.20 for the remaining 2 hours.

The bulk leached solids was ground to P80 38 μm in a mechanically agitated regrind mill using 3-6 mm ceramic at 50% solids. The ground product was then leached using 125 g/L Na₂CO₃ at 50% solids and pH 10.0 using carbon dioxide sparging. This test was repeated with a finer particle size (P95 38 μm). The results are presented in FIG. 13. The data indicates a finer regrind particle size results in a higher extraction, 37% V extraction with P95 38 μm and 30% extraction with P80 38 μm. The vanadium extraction from the slag, via two stage leach and re-grinding calculates to 68.6% and 65.2%, respectively. The mass gain, which is required to calculate vanadium extraction, was calculated using calcium as an internal standard.

### Example 12

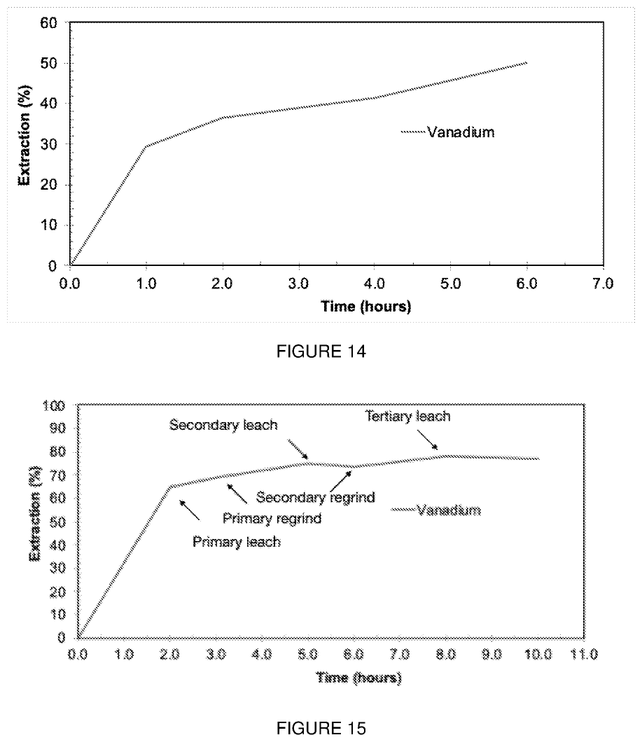

A test was conducted to determine if further vanadium can be extracted from the slag resulting from the regrind and leach trial of Example 11. The P80 38 μm leached solids was re-ground in a mechanically agitated regrind mill using 3-6 mm ceramic at 50% solids. The ground product was then leached using 125 g/L Na₂CO₃ at 50% solids and pH 10.0 using carbon dioxide sparging. The results are presented in FIG. 14. The tertiary leach vanadium extraction reached 53% after 6 hours. The vanadium extraction from the slag, via three stage leach and re-grinding calculates to 81.5%. The mass gain, which is required to calculate vanadium extraction, was calculated using calcium as an internal standard. The data indicates further grinding and leaching extracts more vanadium.

### Example 13

The extraction of vanadium from slag was assessed by processing the slag through a series of leach and regrind tests without filtration and reagent replenishment. This was conducted to determine if high vanadium extraction could be achieved via a single pass of slurry through several regrinding/leach steps. The results are presented in FIG. 15. The vanadium extraction reached 65% after primary leaching. The vanadium extraction increased to 69% after primary regrinding and then to 75% after secondary leaching. There was a small decrease in vanadium extraction after secondary regrinding (74%) and then increased to 77% after tertiary leaching.

### Example 14

The recovery of vanadium from the leach solution by way of solvent extraction was assessed using Aliquat 336 and Isodecanol in Shellsol 2046. Both pH and distribution isotherm tests were conducting initially using synthetic leach liquor. Two pH isotherm tests were conducted using different reagent concentrations. The first test used 5% Aliquat 336 and 5% isodecanol in the Shellsol 2046 and the second test used 10% Aliquat 336 and 5% isodecanol in Shellsol 2046. The tests involved mixing the organic and synthetic leach liquor at an O/A ratio of 1:1 and taking samples at different pH. The pH was increased using 50% NaOH solution. The results indicate that optimum vanadium extraction occurs in the pH range of 8.5-9.5. The extraction of vanadium is significantly higher when using 10% Aliquat 336 in comparison to 5% Aliquat 336, and suggests there is insufficient extractant for the latter. The extraction of vanadium and silica decreases with increasing pH, with the possibility of selectively scrubbing silica from the loaded organic solution at pH 10.0.

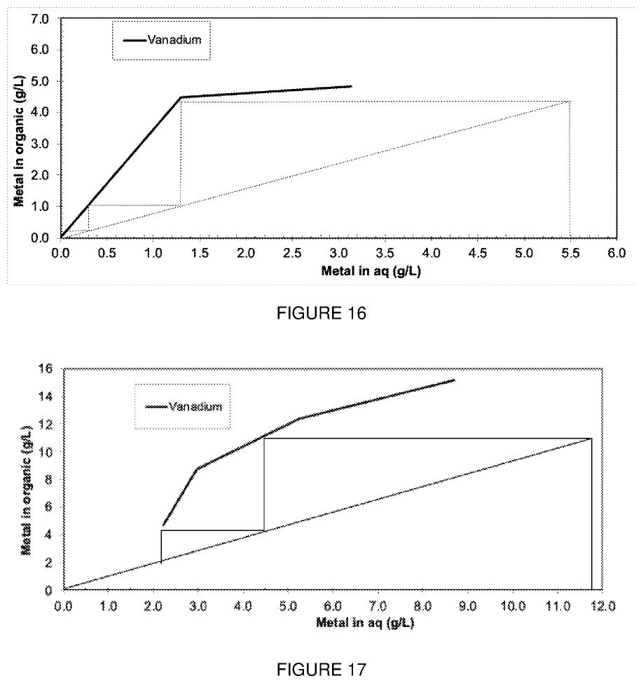

An extraction distribution isotherm was generated by contacting synthetic leach liquor with 10% Aliquat 336 and 5% Isodecanol at different O/A ratios. The results are presented in FIG. 16. The data indicates vanadium can be extracted to <0.1 g/L V in the raffinate using 3 stages at an O/A ratio of 0.8:1.

An extraction isotherm test was conducted using leach liquor recovered from leach tests, containing 11.8 g/L V and 0.49 g/L Si at pH 9.30. The organic contained 20% Aliquat 336 and 10% isodecanol in Shellsol 2046. A higher organic concentration was used than previous tests due to the high vanadium concentration. The isotherm is presented in FIG. 17. The isotherm shows vanadium extraction of approximately 82% in two stages. However, the isotherm shallows and only a minor increase in extraction is expected with a third and fourth stage. Silicon was extracted to a lesser degree in comparison to vanadium. At an O/A ratio of 1:1, the loaded organic contained 8.74 g/L V and 0.177 g/L Si.

### Example 15

A series of trials were conducted to determine whether silicon content of the loaded organic could be reduced in a scrubbing step.

An organic solution containing 10% Aliquat 336 and 5% isodecanol in Shellsol 336 was loaded with a synthetic solution containing 5.5 g/L V, 0.51 g/L Si and 85 g/L NaHCO₃ at an O/A ratio of 1:2. The loaded organic solution contained 4.8 g/L V and 0.13 g/L Si. The loaded organic solution was scrubbed in a single contact with a synthetic solution containing 4.95 g/L V at pH 10.0. The scrubbed organic contained 7.8 g/L V and 0.053 g/L Si. The scrub efficiency for silicon is 59% in a single stage and the V/Si ratio increased from 37:1 to 150:1. A higher scrub efficiency is expected with a second scrub stage. A loading and scrubbing test was repeated using leach liquor generated in the leach trials. The loaded organic contained 12.5 g/L V and 0.23 g/I Si and was scrubbed at an O/A ratio of 1:1 using 3 g/L NaOH. The scrubbed organic contained 12.4 g/L V and 0.20 g/LSi; a scrub efficiency of 30%.

### Example 16

Several tests were conducted to assess the strip liquor composition on the vanadium stripping efficiency from loaded Aliquat 336 and isodecanol. The following strip solutions were trialed.

Sodium Carbonate

10% Aliquat 336 and 5% isodecanol in Shellsol 2046 was loaded with vanadium by contacting with leach liquor containing 3.3 g/L V at pH 9.0 and an O/A ratio of 1:10. The loaded organic was expected to contain approximately 5 g/L V. The loaded organic was contacted with a solution containing 200 g/L Na₂CO₃ at O/A ratios of 5:1, 2:1 and 1:1, returning vanadium concentrations of 2.3 g/L V, 2.6 g/L V and 2.6 g/L V, respectively, indicating a depressed isotherm.

Ammonium Carbonate

10% Aliquat 336 and 5% isodecanol in Shellsol 2046 was loaded with vanadium by contacting with leach liquor containing 3.3 g/L V at pH 9.0 and an O/A ratio of 1:10. The loaded organic was expected to contain approximately 5 g/L V. The loaded organic was contacted with a solution containing 200 g/L (NH₄)₂CO₃ at O/A ratios of 2:1 and 1:1, returning vanadium concentrations of 2.7 g/L V and 2.3 g/L V, respectively. This indicates a depressed isotherm.

Ammonium Chloride/Carbonate and Ammonia

10% Aliquat 336 and 5% isodecanol in Shellsol 2046 was loaded and scrubbed with synthetic vanadium liquors to produce a loaded organic containing approximately 8 g/L V. The loaded organic was contacted with a solution containing 1.5M NH₄Cl and 3M NH₃ at O/A ratios of 5:1, 2:1, 1:1, 1:2 and 1:5 at 50° C. Crystallisation occurred in all contacts and was more prevalent with the higher O/A ratios. These crystals contain vanadium. The liquor, post removal of the crystals, contained 1.7, 0.98, 0.86, 0.77 and 1.2 g/L V, respectively. The test was repeated using 1.5M (NH₄)₂CO₃ and 3M NH₃. Similar crystallisation was observed.

Sulfuric Acid

10% Aliquat 336 and 5% Isodecanol in Shellsol 2046 was contacted with synthetic leach liquor containing 5 g/L V and 85 g/L NaHCO₃ at an O/A ratio of 1:2. The loaded organic, containing 2.2 g/L V, was contacted with a solution containing 20 g/L H₂SO₄ at an O/A ratio of 1:1. The pH was subsequently reduced to assess the impact of pH on vanadium stripping. Relatively high stripping efficiency (65%) was achieved with 20 g/L H₂SO₄ at an O/A ratio of 1:1, and equilibrium pH of 1.25. The stripping efficiency increased to 80% at pH 0.81.

Sodium Hydroxide

Sodium hydroxide solution was assessed as a vanadium stripping agent from loaded organic. A stripping isotherm was conducted using an organic solution containing 20% Aliquat 336, 10% isodecanol in Shellsol 2046, 12.5 g/L V and 0.2 g/L Si and a strip solution containing 125 g/NaOH. A high stripping efficiency (90%) is expected in 3 stages at an O/A ratio of approximately 5:1. The loaded strip liquor is expected to contain 55 g/L V. With 125 g/L NaOH as stripping agent, the loaded strip liquor will consist of a Na/V ratio of 1.31 (mole ratio of 3:1). The vanadium is present as sodium orthovanadate (Na₃VO₄) in the loaded strip liquor.

Potassium Hydroxide

Potassium hydroxide solution was also assessed as a vanadium stripping agent from loaded organic. A stripping isotherm was conducted using an organic solution containing 20% Aliquat 336, 10% isodecanol in Shellsol 2046 and 11.8 g/L V and a strip solution containing 130 g/KOH. A high stripping efficiency (>85%) is expected in 3 stages at an O/A ratio of approximately 3:1. The loaded strip liquor is expected to contain 35 g/L V. With 130 g/L KOH as stripping agent, the loaded strip liquor will consist of a K/V mass ratio of 2.60 (mole ratio of 3.3:1). The vanadium is present as potassium orthovanadate (K₃VO₄) in the loaded strip liquor.

### Example 17

A series of test were conducted to recover a vanadium product from a loaded strip liquor. For these trials, sodium hydroxide was selected as the stripping agent. Initial tests focused on precipitation via acidification (pH 5.0) and ammonium sulfate addition. The results are presented in Table 3.

TABLE 3
Ammonium vanadate test using sodium
orthovanadate containing strip liquor

| | Volume | V | Na | Si | Fe |
|---|---|---|---|---|---|
| Sample | (mL) | (g/L) | (g/L) | (g/L) | (g/L) |
| Loaded strip liquor | 1,019 | 30.5 | 59.6 | 0.39 | 0.01 |
| 500 g/L ammonium sulphate | 140 | — | — | — | — |
| Filtrate | 1,124 | 0.72 | 54.0 | 0.30 | 0.00 |

| | Mass | V | Na | Si | Fe |
|---|---|---|---|---|---|
| | (g) | (%) | (%) | (%) | (%) |
| Solids | 75.2 | 40.3 | 3.85 | 0.18 | 0.19 |

The vanadium recovery to solids was high and reached 97.4%. The product contained 40.3% V, however the sodium grade was high at 3.85% Na.

A vanadium precipitation test was conducted using potassium orthovanadate containing strip liquor via acidification (pH 3.0) and ammonium sulfate addition. The results are presented in Table 4.

TABLE 4
Ammonium vanadate test using potassium
orthovanadate containing strip liquor

| | Volume | V | K | Si | Fe |
|---|---|---|---|---|---|
| Sample | (mL) | (g/L) | (g/L) | (g/L) | (g/L) |
| Loaded strip liquor | 356 | 43.0 | 79.8 | 0.70 | 0.01 |
| Water | 150 | — | — | — | — |
| 500 g/L ammonium sulfate | 100 | — | — | — | — |
| Filtrate + wash | 747 | 4.19 | 41.8 | 0.37 | 0.00 |

| | Mass | V | K | Si | Fe |
|---|---|---|---|---|---|
| | (g) | (%) | (%) | (%) | (%) |
| Solids | 26.0 | 46.3 | 5.82 | 0.82 | 0.15 |

The vanadium recovery to solids was relatively low and reached 79.5%. The product contained 46.3% V, however the potassium grade was high at 5.82% K.

### Example 18

In order to reduce the amount of silicon coprecipitated with vanadium, tests were undertaken to remove silicon from the strip liquor. The sodium vanadate containing loaded strip liquor recovered from the mini plant was acidified to pH 8.0 using 98% sulfuric acid and a stoichiometric addition of aluminium sulfate (as 35 g/L Al solution) was added. The test was conducted at 70° C. for 4 hours. The results are presented in Table 5.

TABLE 5
De-silication test

| | Volume | Mass | Al | V | Na | Si | Fe |
|---|---|---|---|---|---|---|---|
| Sample | (mL) | (g) | (g/L) | (g/L) | (g/L) | (g/L) | (g/L) |
| Loaded strip liquor | 3416 | | | 38.8 | 64.0 | 0.07 | 0.01 |
| 98% sulfuric acid | | 378 | | — | — | — | — |
| 35 g/L Aluminium | 7.00 | | 35.0 | | | | |
| sulphate | | | | | | | |
| Filtrate | 1147 | | 0.01 | 33.4 | 60.6 | 0.00 | 0.01 |

| | Mass | V | Na | Si | Fe |
|---|---|---|---|---|---|
| | (g) | (%) | (%) | (%) | (%) |
| Solids | 8.66 | 10.9 | 18.5 | 5.82 | 4.86 |

The de-silication test was successful with >93% silicon precipitation. The silicon concentration in the loaded strip liquor, post de-silication, was only 4 ppm. The solids contained a high sodium and vanadium concentration, however the losses were <0.6%. Vanadium is expected to be recovered by directing these solids to the leaching circuit.

The de-silication filtrate was reacted with ammonium sulfate at 30° C. for 6 hours. The ammonium sulfate addition was 2 tonnes of ammonium sulfate per tonne of contained vanadium pentoxide in the feed liquor. To prevent co-precipitation of sodium, there was no acid addition in the test as the pH was adjusted in the de-silication test. The results are presented in Table 6.

TABLE 6
Ammonium vanadate test

| | Volume | V | Na | Si | Fe |
|---|---|---|---|---|---|
| Sample | (mL) | (g/L) | (g/L) | (g/L) | (g/L) |
| Desilication filtrate | 2366 | 32.3 | 60.7 | 0.02 | 0.01 |
| 500 g/L ammonium sulfate | 570 | — | — | — | — |
| Filtrate | 2893 | 0.21 | 57.4 | 0.01 | 0.00 |

| | Mass | V | Na | Si | Fe |
|---|---|---|---|---|---|
| | (g) | (%) | (%) | (%) | (%) |
| Solids | 153 | 42.9 | 0.14 | 0.08 | 0.03 |

The ammonium vanadate precipitation test was successful. The vanadium recovery was 99.2% and the ammonium vanadate contained 42.9% V and only 0.14% Na, 0.08% Si, 0.03% Fe and 0.70% S.

### Example 19

The recovered ammonium vanadate was calcined in a batch kiln. The kiln temperature was ramped from ambient temperature to 600° C. over a 2 hour period, then held at 600° C. for two hours and subsequently cooled to ambient. The results are presented in Table 7.

TABLE 7
Vanadium pentoxide test

| | | Solids composition | | | | |
|---|---|---|---|---|---|---|
| | Mass | V | Na | Si | S | Fe |
| Sample | (g) | (%) | (%) | (%) | (%) | (%) |
| Ammonium vanadate | 152 | 42.9 | 0.14 | 0.08 | 0.70 | 0.03 |
| Vanadium pentoxide | 116 | 57.0 | 0.19 | 0.08 | 0.00 | 0.03 |

The de-ammoniation of ammonium vanadate was successful producing a vanadium pentoxide containing 57% V, 0.19% Na, 0.08% Si and 0.03% Fe. If there are no more appreciable impurities, then this product is expected to contain >99.5% V₂O₅.

Those skilled in the art will appreciate that the invention described herein is susceptible to variations and modifications other than those specifically described. The invention includes all such variation and modifications. The invention also includes all of the steps, features, formulations and compounds referred to or indicated in the specification, individually or collectively and any and all combinations or any two or more of the steps or features.

1. A method for the recovery of vanadium from a vanadium containing feed stream, the method comprising the steps of:
subjecting the vanadium feed stream to a leach step, the leach step comprising contacting the vanadium feed stream with an alkaline carbonate leach solution to form a leach slurry comprising a pregnant leach solution containing vanadium and a solid residue;
passing the leach slurry to a solid/liquid separation step to produce a pregnant leach solution containing vanadium; and
recovering a vanadium product from the pregnant leach solution.

2. The method according to claim 1, wherein the alkaline carbonate leach solution comprises one or more of sodium carbonate, sodium bicarbonate, sodium hydroxide, potassium carbonate, potassium bicarbonate and potassium hydroxide.

3. The method according to claim 1, wherein the leach step is conducted under oxidative conditions.

4. The method according to claim 1, wherein the leach step is conducted at pH above 7.5.

5. The method according to claim 1, wherein a carbon dioxide stream is injected into the leach step.

6. The method according to claim 1, wherein the leach step is conducted until the carbonate concentration in the leach slurry is reduced to a target concentration.

7. The method according to claim 1, wherein at least a portion of the leach slurry is subjected to a size reduction step.

8. The method according to claim 7, wherein the size reduction step is conducted during the leach step.

9. The method according to claim 7, wherein at least a portion of the leach slurry is transferred to a size reduction step to produce a process stream with a reduced particle size.

10. The method according to claim 9, wherein the process stream is returned to the leach step.

11. The method according to claim 9, wherein the process stream is subjected to a secondary leach step.

12. The method according to claim 1, wherein the leach slurry is subjected to one or more size reduction steps, wherein each size reduction step is followed by a further leach step.

13. The method according to claim 12, wherein each leach step comprises contacting the slurry with an alkaline carbonate leach solution.

14. The method according to claim 1, wherein the solids recovered in the solid liquid separation step are subjected to a leach step to further extract vanadium.

15. The method according to claim 1, wherein the step of recovering a vanadium product from the pregnant leach solution comprises precipitating a vanadium rich solid and separating the vanadium rich solid from the barren leach solution.

16. The method according to claim 1, wherein the step of recovering a vanadium product from the pregnant leach solution comprises contacting the pregnant leach solution with an ion exchange medium to selectively recover vanadium and separate it from the barren leach solution.

17. The method according to claim 1, wherein the step of recovering a vanadium product from the pregnant leach solution comprises contacting the pregnant leach solution with an organic solution comprising a vanadium extractant and subsequently separating the loaded organic solution from the barren leach solution.

18. The method according to claim 17, wherein vanadium is recovered from the loaded organic solution with a strip solution.

19. The method according to claim 18, wherein the method further comprises the step of recovering vanadium products from the strip solution.

20. The method according to claim 1, wherein the step of recovering a vanadium product from the pregnant leach solution comprises passing the pregnant leach solution to a crystallisation circuit where the sodium carbonate and/or bicarbonate salts are selectively crystalised over vanadium species.

21. The method according to claim 6, wherein the step of recovering a vanadium product from the pregnant leach solution comprises passing the pregnant leach solution to a crystallisation circuit where vanadium species are selectively crystalised.

22. The method according to claim 1, wherein at least a portion of the barren leach solution is recycled to the leach step.

23. The method according to claim 22, wherein the barren leach solution is carbonated prior to being recycled to the leach step.
